(19) United States
(12) Patent Application Publication
(10) Pub. No.: US 2024/0319624 A1
(43) Pub. Date: Sep. 26, 2024

(54) RESIN PARTICLES, TONER, METHOD FOR MANUFACTURING RESIN PARTICLES, IMAGE FORMING APPARATUS, AND METHOD OF FORMING IMAGE

(71) Applicants: Tsuneyasu NAGATOMO, Shizuoka (JP); Junichi WATANABE, Shizuoka (JP); Kohsuke SATOH, Shizuoka (JP); Yuka MIZOGUCHI, Shizuoka (JP)

(72) Inventors: Tsuneyasu NAGATOMO, Shizuoka (JP); Junichi WATANABE, Shizuoka (JP); Kohsuke SATOH, Shizuoka (JP); Yuka MIZOGUCHI, Shizuoka (JP)

(21) Appl. No.: 18/613,267

(22) Filed: Mar. 22, 2024

(30) Foreign Application Priority Data
Mar. 22, 2023 (JP) 2023-045619

(51) Int. Cl. G03G 9/087

(52) U.S. Cl. CPC G03G 9/08755; G03G 9/0804; G03G 9/0825; G03G 9/08782

(57) ABSTRACT

A resin particle may comprise a binder resin, a crystalline polyester resin; and a release agent being in a plurality of domains, which have a domain diameter of 1 μm or less; wherein more than 80% of a surface of each of the plurality of domains of the release agent is covered with the crystalline polyester resin, and a melting point of the crystalline polyester resin is higher than a melting point of the release agent.

### CROSS-REFERENCE TO RELATED APPLICATION

The present application claims priority under 35 U.S.C. § 119 to Japanese Patent Application No. 2023-045619, filed Mar. 22, 2023. The contents of which are incorporated herein by reference in their entirety.

### BACKGROUND OF THE DISCLOSURE

The present disclosure relates to resin particles, toner, method for manufacturing resin particles, image forming apparatus, and method of forming image.

Traditionally, toner made by a kneading and milling method has been used. However, the toner manufactured by the kneading and milling method has problems such as difficulty in reducing the particle size, irregular shape and wide particle size distribution (broadness), insufficient quality of output image, and high fixing energy.

In addition, when wax (a release agent) is added in order to improve fixability, the toner produced by the kneading and milling method tends to crack at the interface with the release agent during milling, resulting in a large amount of release agent on the toner surface. Therefore, while the releasing effect is obtained, deposition (filming) of the toner to the carrier, the photosensitive element, and the blade is likely to occur, and there has been a problem that the overall performance is not satisfactory.

Therefore, to overcome the problem of the kneading and milling method, a method of producing toner by polymerization has been proposed. In addition, the release agent can be internalized. As a method of manufacturing toner by a polymerization method, a method of manufacturing toner from an extension reaction of polyester modified with urethane as a toner binder is disclosed in order to improve low-temperature fixability and high-temperature offset resistance (see, for example, Japanese Unexamined Patent Application Publication No. H11-133665).

In addition, a method of manufacturing a toner having excellent powder fluidity and transfer performance when small-particle-size toner is used, and also excellent heat resistance of storage, low-temperature fixability, and high-temperature offset is disclosed (see, for example, Japanese Unexamined Patent Application Publication No. 2002-287400, 2002-351143).

A method of manufacturing a toner having an aging process for manufacturing a toner binder having a stable molecular weight distribution and achieving both low-temperature fixability and high temperature offset resistance is disclosed (see, for example, Japanese Patent No. 2579150 and Japanese Unexamined Patent Application Publication No. 2001-15881).

However, these proposed techniques do not satisfy the high level of low-temperature fixability required in recent years. Accordingly, for the purpose of obtaining a high level of low-temperature fixability, a toner containing a resin including a crystalline polyester resin and a release agent has been proposed, in which the resin and the release agent are incompatible with each other and have a phase-separated structure in the form of sea islands. (see, for example, Japanese Unexamined Patent Application Publication No. 2004-46095). However, there is a problem that the vicinity where the release agent is present is fragile mechanically, and the toner strength is significantly reduced, especially when the release agent is stored at a high temperature. Although it is disclosed in Japanese Unexamined Patent Application Publication No. 2004-46095 that the release agent is finely dispersed, the release agent has not been able to control the loss of toner strength due to partial seepage during high-temperature storage. Therefore, the toner that contains the release agent internally tends to contaminate the equipment, to have a reduced fluidity and charging property of the toner itself, resulting in a reduced heat-resistant storage stability and image quality. In addition, a toner containing a crystalline polyester resin, a release agent, and a graft polymer has been proposed (see, for example, Japanese Unexamined Patent Application Publication No. 2007-271789). These proposed techniques can achieve low-temperature fixability of a toner because the crystalline polyester resin melts more rapidly than amorphous polyester resin. However, even if the crystalline polyester resins, which has islands in the sea phase-separated structure, melt, most of the amorphous polyester resins, which are the seas, do not yet melt. Thus, since both crystalline polyester resin and amorphous polyester resin must be melted to some extent before fixing, the technology of these proposals does not satisfy the high level of low-temperature fixability that has been expected in recent years. In addition, toner with excellent low-temperature fixability has various problems. One is the trade-off with heat-resistant storage stability. If lower temperature fixability is required, a means that is compatible with the opposing heat-resistant storage stability is required. So far, securing the heat resistance by covering the surface of the toner base particles with resin has been proposed. However, there are problems such as trade-offs with the low-temperature fixability and a decrease in the charge performance (Japanese Patent No. 6024276 and 4873734).

### SUMMARY

In order to solve the above-described problems, one aspect of the present disclosure comprises the following features.

A resin particle, comprising;
a binder resin,
a crystalline polyester resin; and
a release agent being in a plurality of domains, which have a domain diameter of 1 μm or less;
wherein more than 80% of a surface of each of the plurality of domains of the release agent is covered with the crystalline polyester resin, and a melting point of the crystalline polyester resin is higher than a melting point of the release agent.

### BRIEF DESCRIPTION OF THE DRAWINGS

FIG. 1 is a schematic view illustrating another example of an image forming apparatus according to an embodiment of the disclosure.

FIG. 2 is a schematic view illustrating another example of an image forming apparatus according to an embodiment of the disclosure.

FIG. 3 is an enlarged partial view of FIG. 2.

FIG. 4 is a schematic diagram illustrating an example of a process cartridge.

### MODES FOR CARRYING OUT OF THE DISCLOSURE

Hereinafter, resin particles, toner, method for manufacturing resin particles, image forming apparatus, and image forming method according to some embodiments of the present disclosure is described with reference to the drawings as appropriate.

It should be noted that the present disclosure is not limited to the following embodiments, but may be modified within the scope envisioned by a person skilled in the art. Other embodiments, additions, modifications, and deletions are included in the scope of the present disclosure as far as the function and effect of the present disclosure are achieved.

### Resin Particles

The resin particles according to one embodiments of the present disclosure are resin particles containing at least a binder resin and a release agent, wherein the binder resin includes a crystalline polyester resin, a domain diameter of the release agent is 1 μm or less, and 80% or more of the surface of the release agent is covered with a crystalline polyester resin, wherein a melting point of the crystalline polyester resin is higher than a melting point of the release agent. According to this embodiment, it is possible to provide resin particles having excellent low-temperature fixability, heat resistance to storage, and stable image quality.

The “domain diameter” in the present disclosure means an average value of the diameter of each domain.

### <Observation of the Domain of the Release Agent Contained in the Toner by the Transmission Electron Microscope>

The domains of the release agent contained in the toner of the present disclosure is preferably evaluated by the following method using TEM (Transmission Electron Microscope).

The cross-section of the toner observed by the transmission electron microscope (TEM) is prepared as follows. When the toner is stained with ruthenium, the release agent contained in the toner has a large contrast and is easily observed.

When ruthenium staining is used, the amount of ruthenium atoms varies depending on the strength of the staining. The strongly stained areas have more atoms and are not penetrated by the electron beam, resulting in a black color on the observed image, while the weakly stained areas are easily penetrated by the electron beam, resulting in a white color on the observed image.

The following is a description of the procedure for preparing a cross section of ruthenium-stained toner.

First, the toner is immersed in a 0.5 mass % ruthenium tetroxide solution and block stained for 30-90 minutes. Next, the ruthenium-stained toner is encapsulated in a resin mixture of epoxy resin as the main agent and amine as the hardener in the ratio of 1:1 by mass, and allowed to stand for 24 hours. Next, an ultrasonic ultramicrotome (Leica, UC7) is used to cut a length of the toner radius (e.g., 4.0 μm if the weight average particle diameter (D4) is 8.0 μm) from the top surface of the cylinder-shaped resin at a cutting speed of 0.6 mm/s, to produce a cross-section of the toner center. Next, a thin sample of the cross section of the toner is produced by cutting to a film thickness of 250 nm. By cutting in this manner, a cross-section of the toner center can be obtained.

The obtained thin section sample is stained for 15 minutes in a 500 Pa atmosphere of RuO4 gas using a vacuum electron staining apparatus (Filgen, VSC4R1H), and a TEM image is prepared using a scanning transmission electron microscope (JEOL, JEM2100). The obtained TEM images are observed for release agent using image processing software “Image-J”.

### <Measurement of Domain Diameter>

In the present disclosure, the domain diameter of the release agent is the average number of the length or maximum diameters of the domains of the release agent obtained from the above TEM images.

Specifically, TEM images of the 100 cross sections of toners are prepared by the method described above, and the length diameters of all release agent domains in the cross sections of the 100 toners are measured using the “Image-J image processing software”, and the arithmetic mean value is calculated. The arithmetic mean value obtained is used as the domain diameter of the release agent.

Namely, desired characteristics or properties of the toners are small particle sizes and hot offset resistance for forming high-quality output images; low-temperature fixability for achieving energy saving; and heat-resistant storage stability for resisting high temperature and high humidity conditions during storage or transportation after production of the toner. Improvement in low-temperature fixability of a toner is particularly important because energy consumption during fixing constitutes the majority of energy consumption of an entire image formation process. In the resin particles according to one embodiment of the present disclosure, the surface of the finely dispersed release agent is covered with a crystalline polyester resin having a higher melting point than that of the release agent, and the finely dispersed release agent is confined within the toner, resulting in keeping the toner strength high.

The strength of the resin particles as a whole can be increased by finely dispersing domains of release agent with a domain diameter of 1 μm or less in the binding resin. If the domain diameter exceeds 1 μm, the strength of the resin particles is reduced.

In addition, since the release agent is covered by crystalline polyester resin, softening and seepage of the release agent during high-temperature storage are suppressed, resulting in a dramatic improvement in heat storage resistance. In addition, the crystalline polyester resin and the binding resin covering the release agent are compatibilized by heating during fusing, and the finely dispersed release agent quickly seeps out, resulting in a dramatic improvement in low-temperature fusing performance compared to conventional technologies.

The percentage of the release agent surface covered by the crystalline polyester resin is defined as “coverage ratio.”

If the coverage ratio of the release agent surface by crystalline polyester resin, which has a higher melting point than that of the release agent, is 80% or more, the softening and staining of the release agent by heat can be suppressed, and stable resin particles can be maintained even during high temperature storage. If the melting point of the crystalline polyester is lower than that of the release agent, the crystalline polyester is compatibilized with the binding resin by heating, and the release agent's tendency to seep out cannot be suppressed. If the coverage of the release agent surface by the crystalline polyester is less than 80%, the softening of the release agent and the suppression of staining are significantly reduced.

The spherical shape of the release agent is preferable, as it allows the release agent to be well soaked out during the fixing process.

### <Domain Shape of Release Agent>

The domain shape of the release agent can be determined, for example, by the following method. The toner is embedded with visible light curable embedding resin (D-800, made by Nissin EM), cut to 60 nm thickness by ultrasonic ultramicrotome (EM5, made by Leica), and stained with RuO4 by a vacuum staining device (Filogen). Subsequently, observation is performed with a transmission electron microscope (H7500, Hitachi, Japan) at an acceleration voltage of 120 kV. 50 particles were selected from those within ±2.0 μm of the weight average particle diameter and photographed. In the case of the present configuration, the crystalline polyester resin in the toner is projected darker when RuO4 staining is performed, and the release agent is projected even darker when a release agent is used.

The average length diameter and average aspect ratio of the release agent domain can be determined from the observed images, and the average aspect ratio can be calculated using image processing software if necessary.

Image-Pro Plus 5.1J (Media Cybernetics) can be used as the image processing software. Images of cross sections of toner particles taken by the method described above are used. First, the toner particle section is selected to separate the toner particles from the background, and the toner particles to be analyzed are extracted.

Select “Measurement”-“Count/Size” in Image-Pro Plus 5.1J. In the “Count/Size” window, select “Measurement”-“Measurement Items”. Select “Diameter (Min)” and “Diameter (Max)” from the measurement items. In the “Brightness Range Selection,” the brightness range must be adjusted so that only polyester resin A is selected; although the brightness range must be changed each time depending on the RuO4 staining conditions, polyester resin A can be easily identified by the difference in shading. Select “Count” to display the measurement results. The aspect ratio (long diameter/short diameter) can then be obtained by taking the obtained “diameter (minimum)” as the short diameter and the “diameter (maximum)” as the long diameter. From the aspect ratio data of one toner particle thus obtained, the average value of 10 points is obtained in order from the one with the largest diameter (maximum), and this is repeated for 10 toner particles to obtain the average value of aspect ratio. If the aspect ratio is less than 1.4, the toner is considered spherical. The long diameter of the mold release agent should be 1.0 μm or less, and 0.5 μm or less is even more preferable. The larger the long diameter, the more easily the mold release agent is exposed on the toner surface, making the toner soft and deteriorating its thermal stability. In addition, the mold release effect is reduced and low-temperature fixability deteriorates. An aspect ratio of 1.4 or less is preferred, and 1.2 or less is even more preferred. As the aspect ratio increases (non-spherical shape), the coverage of crystalline resin decreases and heat preservation deteriorates.

<Coverage Ratio with Crystalline Polyester Resin>

The domain diameter and shape of the release agent can be determined, for example, by the following method. The toner is embedded with visible light curable embedding resin (D-800, made by Nissin EM), cut to 60 nm thickness by ultrasonic ultramicrotome (EM5, made by Leica), and stained with RuO4 by a vacuum staining device (Filogen). Subsequently, observation is performed with a transmission electron microscope (H7500, Hitachi, Japan) at an acceleration voltage of 120 kV. 50 particles were selected from those within +2.0 μm of the weight average particle diameter and photographed. In the case of the present configuration, the crystalline polyester resin in the toner is projected darker when RuO4 staining is performed, and the release agent is projected even darker when a release agent is used.

The average length diameter and average aspect ratio of the release agent domain can be determined from the observed image, and the average aspect ratio can be calculated using image processing software if necessary.

The coverage of crystalline polyester resin around the release agent was calculated using image processing software (Image-J) as follows.

(1) The perimeters of all release agent domains unevenly distributed in one toner photographed image are surrounded by freehand-sections, and the perimeter length is measured by Analyze to determine the perimeter length W.

(2) The length of the contact area of the crystalline polyester resin in contact with the release agent surface in the photographed image is measured by Freehand-sections and is defined as the coverage length C.

(3) The coverage of crystalline polyester resin on the release agent surface was calculated by substituting the “perimeter length W” calculated in (1) above and the “coverage length C” calculated in (2) above into the following formula (1).

$$Coverage rate by crystalline polyester resin [ \% ] = ( Coverage length C / Perimeter length W ) \times 100 \qquad ( 1 )$$

(4) Perform the above operations (1) to (3) for 50 toner particles, and calculate the average value of the coverage ratio of crystalline polyester resin on the release agent surface of 50 toner particles. This average value was defined as the coverage rate of crystalline polyester resin.

### Method of Manufacturing the Toner

The toner of one embodiment of the present disclosure is manufactured as follows:

a. Oil Phase Preparation Step

In the oil phase preparation step, an oil phase in which a resin, a colorant, a prepolymer, or the like are dissolved or dispersed in an organic solvent is first prepared. In order to prepare the oil phase, a resin, a colorant, or the like may be gradually added to the organic solvent while stirring, and dissolved or dispersed. Known dispersions device such as a bead mill or a disk mill can be used to disperse. The materials used in the oil phase preparation step are described below.

### Polyester Resin

When a resin used for toners for electrostatic latent images in electrophotography, excellent fixability can be obtained by using a resin having a polyester skeleton. Although there are polyester resins and block polymers of polyester and resins having other skeletons as resins having a polyester skeleton, it is preferable to use a polyester resin because the resulting colored resin particles are highly uniform and desirable.

Examples of polyester resins include ring-opening polymers of lactones, condensation polymers of hydroxycarboxylic acids, polycondensates of polyols and polycarboxylic acids, and polycondensates of polyols and polycarboxylic acids are preferably used from the viewpoint of design flexibility.

The weight-average molecular weight of polyester resins is usually 1,000 to 30,000, preferably 3,000 to 15,000, and even more preferably 5,000 to 12,000. When the weight-average molecular weight of polyester resins is less than 1000, the heat resistance of the toner deteriorates, and when the weight-average molecular weight of polyester resins exceeds 30,000, the low temperature fixability of the toner for electrostatic latent image development deteriorates.

The glass transition temperature (Tg) of the polyester resin is preferably 35° C. to 80° C., more preferably 40° C. to 70° C., and even more preferably 45° C. to 65° C. When the Tg is less than 35° C., the colored resin particles may be deformed when placed in a high temperature environment such as mid-summer, or may stick to each other and will not behave as particles as they should. When the Tg exceeds 80° C., the fixability deteriorates when the colored resin particles are used as toner for electrostatic latent image development.

### Polyol

Examples of polyols (1) include diol (1-1) and trivalent or higher polyols (1-2). Polyol is preferably diol (1-1) alone or a mixture of diol (1-1) and a small amount of trivalent or higher polyols (1-2).

Examples of diol (1-1) include alkylene glycol (ethylene glycol, 1,2-propylene glycol, 1,3-propylene glycol, 1,4-butanediol, 1,6-hexanediol, and the like); alkylene ether glycol (diethylene glycol, triethylene glycol, dipropylene glycol, polyethylene glycol, polypropylene glycol, polytetramethylene ether glycol, neopentyl glycol, and the like); alicyclic diol (1,4-cyclohexanedimethanol, hydrogenated bisphenol A, and the like); bisphenols (bisphenol A, bisphenol F, bisphenol S, and the like); alkylene oxide (ethylene oxide, propylene oxide, butylene oxide, and the like) adducts of the above alicyclic diols; 4,4′-dihydroxybiphenyls such as 3,3′-difluoro-4,4′-dihydroxybiphenyls; bis(3-fluoro-4-hydroxyphenyl) alkanes such as bis(3-fluoro hydroxyphenyl)methane, 1-phenyl-1,1-bis(3-fluoro-4 hydroxyphenyl)ethane, 2,2-bis (3-fluoro-4 hydroxyphenyl)propane, 2,2-bis(3,5-difluoro-4-hydroxyphenyl)propane (also known as: tetrafluorobisphenol A), 2,2-bis(3-hydroxyphenyl)-1,1,1,3,3,3-hexafluoropropane; bis(4-hydroxyphenyl)ethers such as bis(3-fluoro-4-hydroxyphenyl)ethers; and alkylene oxide (ethylene oxide, propylene oxide, butylene oxide, and the like) adducts of the above bisphenols. Among these, alkylene glycol having a carbon number of 2 to 12 and alkylene oxide adducts of bisphenols are preferably used, and alkylene oxide adducts of bisphenols and their combination with alkylene glycol having a carbon number of 2 to 12 are particularly preferably used. Examples of trivalent or higher polyol (1-2) include polyaliphatic alcohols with a valence of from three to eight or higher than eight (glycerin, trimethylolethane, trimethylolpropane, pentaerythritol, sorbitol, and the like); trivalent or higher phenols (tris phenol PA, phenol novolac, cresol novolac, and the like); alkylene oxide adducts of trivalent or higher polyphenols.

### Polycarboxylic Acid

Examples of polycarboxylic acids (2) include dicarboxylic acid (2-1) and trivalent or higher polycarboxylic acid (2-2). Polycarboxylic acid (2) is preferably dicarboxylic acid (2-1) alone or a mixture of dicarboxylic acid (2-1) and a small amount of trivalent or higher polycarboxylic acid (2-2).

Examples of dicarboxylic acid (2-1) include alkylenedicarboxylic acid (succinic acid, adipic acid, sebacic acid, and the like); alkenylenedicarboxylic acid (phthalic acid, isophthalic acid, terephthalic acid, naphthalenedicarboxylic acid, etc.), 3-fluoroisophthalic acid, 2-fluoroisophthalic acid, 2-fluoroterephthalic acid, 2,4,5,6-tetrafluoroisophthalic acid, 2,3,5,6-tetrafluoroterephthalic acid, 5-trifluoromethylisophthalic acid, 2,2-bis(4-carboxyphenyl)hexafluoropropane, 2,2-bis(3-carboxyphenyl)hexafluoropropane,2,2′-bis(trifluoromethyl)-4,4′-biphenyldicarboxylic acid, 3,3′-bis(trifluoromethyl)-4,4′-biphenyldicarboxylic acid, Examples include hexafluoroisopropylidene diphthalic anhydride.

Among these, alkenylenedicarboxylic acid having a carbon number of 4 to 20 and aromatic dicarboxylic acid having a carbon number of 8 to 20 are preferably used.

Examples of trivalent or higher polycarboxylic acid (2-2) include aromatic polycarboxylic acid having a carbon number of 9 to 20 (trimellitic acid, pyromellitic acid, and the like).

The polycarboxylic acid (2) may be reacted with the polyol (1) using an acid anhydride or a lower alkyl ester (methyl ester, ethyl ester, isopropyl ester, and the like) of the above.

The ratio of the polyol to the polycarboxylic acid is usually 2/1 to 1/2, preferably 1.5/1 to 1/1.5, even more preferably 1.3/1 to 1/1.3, as the equivalence ratio of the hydroxyl group [OH] to the carboxyl group [COOH] ([OH]/[COOH]).

### Other Binder Resins

The core constituting the toner according to one embodiment may contain the following binder resin. Examples of the other binder resins include silicone resins, styrene/acrylic resins, styrenic resins, acrylic resins, epoxy resins, diene-based resins, phenolic resins, terpene resins, terpene phenolic resins, coumarin resins, amidoimide resins, butyral resins, urethane resins, ethylene/vinyl acetate resins, or the like. A binder resin may include an amorphous polyester resin synthesized from aliphatic alcohol monomers.

### Colorant

The colorant is not particularly limited, and may be appropriately selected in accordance with the intended purpose. Examples of the colorant include carbon black, a nigrosine dye, iron black, naphthol yellow S, Hansa yellow (10G, 5G, G), cadmium yellow, yellow iron oxide, yellow ocher, yellow lead, titanium yellow, polyazo yellow, oil yellow, Hansa yellow (GR, A, RN, R), pigment yellow L, benzidine yellow (G, GR), permanent yellow (NCG), Vulcan fast yellow (5G, R), tartrazine lake, quinoline yellow lake, anthrasan yellow BGL, isoindolinon yellow, red iron oxide, red lead, lead vermilion, cadmium red, cadmium mercury red, antimony vermilion, permanent red 4R, parared, fiser red, parachloroorthonitro aniline red, lithol fast scarlet G, brilliant fast scarlet, brilliant carmine BS, permanent red (F2R, F4R, FRL, FRLL and F4RH), fast scarlet VD, vulcan fast rubin B, brilliant scarlet G, lithol rubin GX, permanent red F5R, brilliant carmine 6B, pigment scarlet 3B, Bordeaux 5B, toluidine Maroon, permanent Bordeaux F2K, Helio Bordeaux BL, Bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, Victoria blue lake, metal-free phthalocyanine blue, phthalocyanine blue, fast sky blue, indanthrene blue (RS and BC), indigo, ultramarine, iron blue, anthraquinone blue, fast violet B, methyl violet lake, cobalt purple, manganese violet, dioxane violet, anthraquinone violet, chrome green, zinc green, chromium oxide, viridian, emerald green, pigment green B, naphthol green B, green gold, acid green lake, malachite green lake, phthalocyanine green, anthraquinone green, titanium oxide, zinc flower, lithopone, and mixtures thereof.

### Organic Solvent

it is preferable to use a volatile solvent with a boiling point of less than 100° C. because the volatile solvent makes it easier to remove the organic solvent later. Examples of the organic solvents include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, methyl isobutyl ketone, methanol, ethanol, isopropyl alcohol, or the like. These can be used alone or in combination of two or more kinds. When the resin to be dissolved or dispersed in the organic solvent is a resin having a polyester skeleton, ester solvents such as methyl acetate, ethyl acetate, and butyl acetate or ketone solvents such as methyl ethyl ketone and methyl isobutyl ketone are preferably used because of their high solubility. Among these, methyl acetate, ethyl acetate, and methyl ethyl ketone are particularly preferred because of their high solvent removability.

### Prepolymer

The prepolymer is a resin having a group that can react with the curing agent. In one embodiment, it is contained in the resin particles as a “polyester resin (hereinafter referred to as “polyester resin A”) after the resin particles are manufactured.

The prepolymer (reactive precursor) may include a polyester having a group that can react with an active hydrogen group. Examples of groups that can react with active hydrogen groups include isocyanate groups, epoxy groups, carboxylic acids, acid chloride groups, and the like. Among these, isocyanate groups are preferable in that urethane or urea bonds can be introduced into the amorphous polyester resin.

The prepolymer may have branched structures imparted by at least one of trivalent or higher alcohols and trivalent or higher carboxylic acids.

Examples of polyester resins containing isocyanate groups include reaction products of polyisocyanates with polyester resins having active hydrogen groups.

The polyester resins having active hydrogen groups are obtained, for example, by polycondensation of a diol, a dicarboxylic acid, and at least one of a trivalent or higher alcohol and a trivalent or higher carboxylic acid.

Trivalent or higher alcohols and trivalent or higher carboxylic acids impart branched structures to polyester resins containing isocyanate groups.

Examples of diols include aliphatic diols such as ethylene glycol, 1,2-propylene glycol, 1,3-propylene glycol, 1,4-butanediol, 2-methyl-1,3-propanediol, 1,5-pentanediol, 3-methyl-1,5-pentanediol, 1,6-hexanediol, 1,8-octanediol, 1,10-decanediol, 1,12-dodecanediol, and the like; diols having oxyalkylene groups such as diethylene glycol, triethylene glycol, dipropylene glycol, polyethylene glycol, polypropylene glycol, polytetramethylene glycol, and the like; alicyclic diols such as 1,4-cyclohexane dimethanol, hydrogenated bisphenol A, and the like; alicyclic diols with alkylene oxides such as ethylene oxide, propylene oxide, butylene oxide added, and the like; bisphenols such as bisphenol A, bisphenol F, and bisphenol S; alkylene oxide adducts of bisphenols such as those in which alkylene oxides such as ethylene oxide, propylene oxide, butylene oxide, and the like are added to bisphenols. Among these, from the viewpoint of controlling the glass transition point of polyester resin (A) to 20° C. or lower, aliphatic diols having a carbon number of 3 to 10 such as 1,2-propylene glycol, 1,3-propylene glycol, 1,4-butanediol, 2-methyl-1,3-propanediol, 1,5-pentanediol, 3-methyl-1,5-pentanediol, and the like are preferably used, and 50% by mol or more of the alcohol component in the resin is more preferably used. These diols may be used alone or in combination of two or more.

It is desirable that the polyester resin (A) is an amorphous resin and that the steric hindrance of the resin chain reduces the melt viscosity at the time of fixing, making it easier to develop low-temperature fixability. For this reason, it is preferable that the main chain of the aliphatic diol has a structure represented by general formula (1) below.

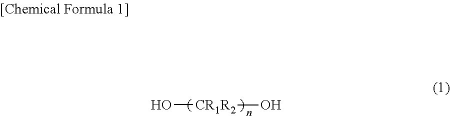

In the formula, R₁ and R₂ each independently represent a hydrogen atom or an alkyl group having a carbon number of 1 to 3, and n represents an odd number of 3 to 9. In the n repeating units, R₁ and R₂ may be the same or different from each other.

Here, the main chain of an aliphatic diol is a carbon chain connected between the two hydroxyl groups of the aliphatic diol in the shortest carbon number. When the carbon number of the main chain is an odd number, it is preferable because the crystallinity decreases due to the Odd-Even effects. Also, when the side chain has at least 1 or more alkyl groups having a carbon number of 1 to 3, it is more preferable because the interaction energy between the main chain molecules decreases due to stericity.

Examples of dicarboxylic acid include aliphatic dicarboxylic acids such as succinic acid, adipic acid, sebacic acid, dodecanedioic acid, maleic acid, fumaric acid, and the like; aromatic dicarboxylic acids such as phthalic acid, isophthalic acid, terephthalic acid, naphthalenedicarboxylic acid, and the like. These anhydrides, lower (having a carbon number of 1 to 3) alkyl esters and halides may also be used. Among these, from the viewpoint of controlling the glass transition temperature (Tg) of the polyester resin (A) to be 20° C. or lower, an aliphatic dicarboxylic acid having a carbon number of 4 to 12 is preferably used, and 50% by mass or more of the carboxylic acid component in the resin is more preferably used. These dicarboxylic acids may be used alone, or two or more may be used in combination.

Examples of trivalent or higher alcohols include trivalent or higher aliphatic alcohols such as glycerin, trimethylolethane, trimethylolpropane, pentaerythritol, sorbitol, and the like; trivalent or higher polyphenols such as 4(4(1,1-bis(p-hydroxyphenyl) ethyl)α,α-dimethylbenzyl)phenol, phenol novolac, cresol novolac, and the like. Examples of trivalent polyphenols include alkylene oxide adducts of trivalent or higher polyphenols such as ethylene oxide, propylene oxide, butylene oxide added, and the like to trivalent or higher polyphenols.

Examples of trivalent or higher carboxylic acids include trivalent or higher aromatic carboxylic acids having a carbon number of 9 to 20 such as trimellitic acid, pyromellitic acid, and the like. These anhydrides, lower (having a carbon number of 1 to 3) alkyl esters and halides may also be used.

Examples of polyisocyanates include diisocyanates, trivalent or higher isocyanates, and the like. The polyisocyanates are not particularly limited and may be selected according to purpose. Examples of polyisocyanates include aliphatic diisocyanates such as 1,3- and/or 1,4-phenylene diisocyanate, 2,4- and/or 2,6-trilene diisocyanate (TDI), crude TDI, 2,4′ and/or 4,4′-diphenylmethane diisocyanate (MDI), crude MDI [crude diaminophenylmethane [mixture of formaldehyde and aromatic amine (aniline) or mixtures thereof; mixture of diaminodiphenylmethane and three or more functional polyamines (e.g., 5-20 wt %)], polyallyl polyisocyanate (PAPI), 1,5-naphthylene diisocyanate, 4,4′,4″-triphenylmethane triisocyanate, etc. aromatic diisocyanates such as m- and p-isocyanatophenylsulfonyl isocyanates, ethylene diisocyanate, tetramethylene diisocyanate, hexamethylene diisocyanate (HDI), dodecamethylene diisocyanate, 1,6,11-undecanetriisocyanate, 2,2,4-trimethylhexamethylene diisocyanate, lysine diisocyanate, 2,6-diisocyanatomethyl caproate, bis(2-isocyanatoethyl)fumarate, bis(2-isocyanatoethyl)carbonate, 2-isocyanatoethyl-2,6-diisocyanatohexanoate; alicyclic diisocyanates such as isophorone diisocyanate (IPDI), dicyclohexylmethane-4,4′-diisocyanate (hydrous MDI), cyclohexylene diisocyanate, methylcyclohexylene diisocyanate (hydrogenated TDI), bis(2-isocyanatoethyl)-4-cyclohexene-1,2-dicarboxylate, and 2,5- and 2,6-norbornandiisocyanate; aromatic aliphatic diisocyanates such as m- and p-xylylene diisocyanate (XDI), α,α,α′,α′-tetramethyl xylylene diisocyanate (TMXDI); trivalent or higher polyisocyanates such as lysine triisocyanate, diisocyanate modifications of trivalent or higher alcohol; modified those isocyanates; may be a mixture of these two or more. Examples of the modified those isocyanates include urethane, carbodiimide, allophanate, urea, burette, urethodione, urethoimine, isocyanurate, and oxazolidone group-containing modified isocyanates.

### Charge Control Agent

A charge control agent or the like may be added to the oil phase.

All known charge control agents can be used. Examples of the charge-controlling agent include a nigrosine-based dye, a triphenylmethane-based dye, a chrome-containing metal complex dye, a molybdic acid chelate pigment, a rhodamine-based dye, an alkoxy-based amine, a quaternary ammonium salt (including fluorine-modified quaternary ammonium), an alkylamide, phosphorus or a phosphorus compound, tungsten or a tungsten compound, a fluorosurfactant, a metal salt of salicylic acid, and a metal salt of a salicylic acid derivative. Specific examples of the charge-controlling agent include: nigrosine dye BONTRON 03, quaternary ammonium salt BONTRON P-51, metal-containing azo dye BONTRON S-34, oxynaphthoic acid-based metal complex E-82, salicylic acid-based metal complex E-84, and phenol condensate E-89 (all manufactured by ORIENT CHEMICAL INDUSTRIES CO., LTD); quaternary ammonium salt molybdenum complex TP-302 and TP-415 (all manufactured by Hodogaya Chemical Co., Ltd.); copy charge PSY VP2038 of the quaternary ammonium salt, copy blue PR of the triphenylmethane derivative, copy charge NEG VP2036 of the quaternary ammonium salt, copy charge NX VP434 of the triphenylmethane derivative (all manufactured by Hoechst), LRA-901, and boron complex LR-147 (manufactured by Japan Carlit Co., Ltd. copper phthalocyanine; perylene; quinacridone; an azo pigment; and a polymer compound including a functional group, such as a sulfonic acid group, a carboxyl group, and a quaternary ammonium salt.

The charge control agent may be used in an amount in the range in which it exhibits performance and does not inhibit fixability or the like, and may contain from 0.5% to 5% by mass, preferably from 0.8% to 3% by mass in the toner.

b. Phase Transfer Emulsification Step

In the phase transfer emulsification step, the oil phase obtained in the oil-phase preparation step is finely particulated.

In one embodiment, after neutralizing the oil phase described above with a neutralizing agent, the aqueous phase is added to it, and the fine particle dispersion liquid is obtained by phase transformation emulsification, which converts from a water-in-oil type dispersion liquid (water-in-oil emulsion) to an oil-in-water type dispersion liquid (oil-in-water emulsion).

The neutralizing agent may be either a basic inorganic compound or a basic organic compound. Examples of the basic inorganic compounds include sodium hydroxide, potassium hydroxide, lithium hydroxide, ammonia, sodium carbonate, sodium bicarbonate, potassium carbonate, potassium bicarbonate, ammonia, or the like. Examples of the basic organic compounds include N,N-dimethylethanolamine, N,N-diethylethanolamine, triethanolamine, tripropanolamine, tributanolamine, triethylamine, n-propylamine, n-butylamine, isopropylamine, monomethanolamine, morpholine, methoxypropylamine, pyridine, vinylpyridine, isophorone diamine, or the like.

The neutralization is performed using ordinary agitators and dispersing equipment while mixing and dispersing uniformly. Examples of the dispersion device include, but are not limited to, an ultrasonic dispersor, a bead mill, a ball mill, a roll mill, a homomixer, an ultra-mixer, a disperser, an through-type high-pressure dispersor, an impingement type high-pressure dispersor, a porous high-pressure disperser, an ultra-high-pressure homogenizer, an ultra-high-pressure homogenizer, and an ultra-sonic homogenizer. Conventional stirrers and dispersion devices may be combined.

Examples of the aqueous phase include ion-exchanged water or ion-exchanged water containing organic solvent. Examples of organic solvent include ester-based solvents such as methyl acetate, ethyl acetate, butyl acetate, or ketone-based solvents such as methyl ethyl ketone and methyl isobutyl ketone. The organic solvent concentration may be less than or equal to the saturation concentration with respect to ion-exchanged water from the viewpoint of granulation performance.

The emulsification is performed using ordinary agitators and dispersing equipment while mixing and dispersing uniformly. Examples of the dispersion device include, but are not limited to, an ultrasonic dispersor, a bead mill, a ball mill, a roll mill, a homomixer, an ultra-mixer, a disperser, an through-type high-pressure dispersor, an impingement type high-pressure dispersor, a porous high-pressure disperser, an ultra-high-pressure homogenizer, an ultra-high-pressure homogenizer, and an ultra-sonic homogenizer. Conventional stirrers and dispersion devices may be combined.

c. Desolvating Step

The organic solvent is removed from the resulting fine particle dispersion.

There are four methods for removing organic solvents.
(1) A method in which the entire system is stirred and the temperature of the entire system is gradually raised to completely evaporate the organic solvent in the droplets.
(2) a method in which the resulting fine particle dispersion is sprayed into a dry atmosphere with stirring to completely remove the organic solvent in the droplets.
(3) A method in which fine particle dispersion is reduced in pressure with stirring to evaporate and remove the organic solvent.
(4) A method in which fine particle dispersion is stirred and a gas is blown on it to evaporate and remove the organic solvent.

The method (2), (3), and (4) may be used in combination with the method (1).

As the drying atmosphere in which fine particle dispersion is sprayed, various air currents heated to a temperature above the boiling point of the highest boiling solvent used are generally used, including air, nitrogen, carbon dioxide gas, combustion gas, and other heated gases. Short-term treatment of spray dryers, belt dryers, rotary kilns, or the like provides sufficient target quality. Example of the gas to be sprayed include air, nitrogen, carbon dioxide, combustion gas. The fine particle dispersion liquid can be obtained by this method.

d. Agglomerating Step

Next, the resulting colored fine particle dispersion liquid is agglomerated with stirring until it reaches the desired particle diameter. Conventional methods can be used to cause agglomeration, such as adding an agglomerating agent or adjusting pH. When an agglomerating agent is added, the agglomerating agent may be added as is, but the agglomerating agent is preferably converted into an aqueous solution so that a localized increase in concentration is avoided. In addition, it is preferable that the agglomerated salt be gradually added while observing the particle size of the colored particles.

The temperature of the dispersion liquid during agglomeration is preferably near the Tg of the resin used. If the temperature is too low, agglomeration will not proceed very well, resulting in inefficiency. If the temperature is too high, agglomeration rate increases and the particle size distribution deteriorates, including the generation of coarse particles.

When the particle size becomes a desired particle size, the agglomeration is stopped. Methods for stopping agglomeration include adding salts or chelating agents with low ionic valence, adjusting the pH, lowering the temperature of the dispersion liquid, and diluting the concentration by adding a large amount of aqueous medium.

The dispersion liquid of the colored agglomerated particles can be obtained by the above method.

In the agglomerating step, a wax may be added as a release agent and/or crystalline resin may be added for low temperature fixability. In such cases, a dispersion liquid in which the wax is dispersed in an aqueous media or a dispersion liquid in which the crystalline resin is dispersed is mixed with the fine particle dispersion liquid is agglomerated, resulting in obtaining agglomerated particles that the wax or the crystalline resin is evenly dispersed.

Hereinafter, an agglomerating agent, wax, and crystalline resin are described.

### Agglomerating Agent

As an agglomerating agent, a known agent can be used. Examples of agglomerating agent include a metal salt of a monovalent metal such as sodium or potassium, a metal salt of a divalent metal such as calcium or magnesium, or a metal salt of a trivalent metal such as iron or aluminum.

### Wax

The wax is not particularly limited and can be selected appropriately according to the purpose, but a release agent with a low melting point of 50° C. to 120° C. is preferably used. When the release agent having low-temperature melting point is dispersed with a binder resin, the release agent effectively acts between fixing rollers and the interfaces of the resin particles, thereby providing excellent hot offset even without oil (no release agent like oil is applied to the fixing roller).

The release agent include, for example, natural waxes including botanical waxes such as carnauba wax, cotton wax, japan wax, and rice wax; animal waxes such as beeswax, and lanolin; mineral-based waxes such as ozocerite, and ceresin; and petroleum waxes such as paraffin, microcrystalline, and petrolatum. In addition to these natural waxes, synthetic hydrocarbon waxes such as Fischer-Tropsch waxes and polyethylene waxes; synthetic waxes such as esters, ketones, ethers, and the like are also included. Furthermore, aliphatic acid amides such as 12-hydroxystearic acid amide, amide stearate, phthalimide anhydride, or chlorinated hydrocarbons; homopolymers or copolymers of polyacrylate such as poly-n-stearyl methacrylate, or poly-n-lauryl methacrylate, which is a crystalline high polymer resin with a low molecular weight (e.g. a copolymer of n-stearyl acrylate-ethyl methacrylate); a crystalline polymer having a long alkyl group in the side chain; and the like may be used. Among these, synthetic waxes are preferred, and ester waxes are more preferred because they ensure high dispersibility and charge stability. They may be used alone or in combination with more than one.

The melting point of the wax is not particularly limited, and can be appropriately selected according to the purpose. The melting point preferably is within a range from 50° C. to 120° C., and more preferably is within a range from 60° C. to 90° C. When the melting point is 50° C. or higher, it is possible to suppress bad influence brought from the wax to the heat-resistant storage stability. When the melting point is 120° C. or lower, it is possible to effectively suppress an occurrence of a cold offset at the time of fixing at low temperature.

A melt viscosity of the wax, as a measured value at a temperature higher than the melting point of the wax by 20° C., preferably is within a range from 5 cps to 1,000 cps, and more preferably is within a range from 10 cps to 100 cps. When the melt viscosity is 5 cps or more, it is possible to prevent the releasability from being decreased. When the melt viscosity is 1,000 cps or less, effects of hot offset resistance and the low-temperature fixing property can be exhibited sufficiently.

The content of the wax in the resin particles is not particularly limited, and can be appropriately selected according to the purpose. The content preferably is within a range from 0% by mass to 40% by mass, and more preferably is within a range from 3% by mass to 30% by mass. If the wax content is 40% by mass or less, deterioration of toner flowability can be prevented.

### Crystalline Polyester

Crystalline polyester resins are obtained from polyvalent alcohols and polyvalent carboxylic acids such as polycarboxylic acids, polycarboxylic anhydrides, polycarboxylic acid esters, and derivatives thereof.

The crystalline polyester resin according to one embodiment of the present disclosure refers to a polyvalent alcohol and a polyvalent carboxylic acid such as a polyvalent carboxylic acid, a polycarboxylic acid anhydride, a polycarboxylic acid ester, or derivatives thereof, as described above. A resin modified from the polyester resin, such as a prepolymer and a resin obtained by crosslinking and/or extending the polyester resin, does not belong to the crystalline polyester resin.

### Polyvalent Alcohol

Polyvalent alcohols are not particularly limited and can be appropriately selected according to the purpose. For example, diols and trivalent or higher alcohols can be used.

Examples of the diol include saturated aliphatic diols. The saturated aliphatic diols include linear saturated aliphatic diols and branched saturated aliphatic diols. Among them, linear saturated aliphatic diols are preferably used, and linear saturated aliphatic diols having a carbon number of 2 to 12 are more preferably used. If the saturated aliphatic diol is branched, the crystallinity of the crystalline polyester resin may be decreased and the melting point may be lowered. Also, when the carbon number of the saturated aliphatic diol exceeds 12, it becomes difficult to obtain a material of practical use.

Examples of saturated aliphatic diol include ethylene glycol, 1,3-propanediol, 1,4-butanediol, 1,5-pentanediol, 1,6-hexanediol, 1,7-heptanediol, 1,8-octanediol, 1,9-nonandiol, 1,10-decanediol, 1,11-undecandiol, 1,12-dodecanediol, 1,13-tridecanediol, 1,14-tetradecanediol, 1,18-octadecanediol, 1,14-eicosandiol, or the like. Among these, ethylene glycol, 1,4-butanediol, 1,6-hexanediol, 1,8-octanediol, 1,9-nonanediol, 1,10-decanediol, and 1,12-dodecanediol are preferable in that the crystalline polyester resin has a high crystallinity and excellent sharp melt properties. Examples of the alcohol having a valence of 3 or higher include glycerin, trimethylol ethane, trimethylol propane, pentaerythritol, and the like. They may be used alone or in combination with two or more.

### Polyvalent Carboxylic Acid

Polyvalent carboxylic acids are not particularly limited and can be appropriately selected according to the purpose. For example, divalent carboxylic acids and trivalent or higher carboxylic acids can be used.

Examples of the divalent carboxylic acids include saturated aliphatic dicarboxylic acids such as oxalic acid, succinic acid, glutaric acid, adipic acid, speric acid, azelaic acid, sebacic acid, 1,9-nonandicarboxylic acid, 1,10-decanedicarboxylic acid, 1,12-dodecanedicarboxylic acid, 1,14-tetradecandicarboxylic acid, 1,18-octadecanedicarboxylic acid; aromatic dicarboxylic acids such as phthalic acid, isophthalic acid, terephthalic acid, naphthalene-2,6-dicarboxylic acid, malonic acid, mesaconic acid, their anhydrides and their lower (having a carbon number of 1 to 3) alkyl esters.

Examples of trivalent or higher carboxylic acids include 1,2,4-benzenetricarboxylic acid, 1,2,5-benzenetricarboxylic acid, 1,2,4-naphthalenetricarboxylic acid, and their anhydrides and their lower (having a carbon number of 1 to 3) alkyl esters. These may be used alone or in combination of two or more.

The crystalline polyester resin is preferably composed of a linear saturated aliphatic dicarboxylic acid having a carbon number of 4 to 12 and a linear saturated aliphatic diol having a carbon number of 2 to 12. Such structure enables an excellent low-temperature fixability to be exerted because of the high crystallinity and excellent sharp-melt properties.

In addition, methods for controlling the crystallinity and softening point of crystalline polyester resins include designing and using non-linear polyesters or the like that undergo condensation polymerization by adding trivalent or higher polyvalent alcohol such as glycerin to the alcohol component or trivalent or higher polyvalent carboxylic acid such as trimellitic anhydride to the acid component during polyester synthesis.

The molecular structure of crystalline polyester resins of this disclosure can be confirmed by NMR measurements in solutions and solids, as well as X-ray diffraction, GC/MS, LC/MS, IR measurements, and the like. However, in the infrared absorption spectra, examples can be taken that have absorption based on the 8CH (out-of-plane bending vibration) of olefins at 965±10 cm⁻¹ or 990±10 cm⁻¹.

In terms of molecular weight, those with a narrow molecular weight distribution and a low molecular weight are excellent in low-temperature fixability, while many components with a low molecular weight deteriorate heat-resistant storage. From this point of view, it is preferable that the molecular weight distribution by GPC of the soluble part of o-dichlorobenzene has a peak position in the range of 3.5 to 4.0 on the molecular weight distribution map with log (M) on the horizontal axis and % by mass on the vertical axis, a peak width at half maximum of 1.5 or less, a weight-average molecular weight (Mw) of 3,000 to 30,000, a number-average molecular weight (Mn) of 1,000 to 10,000, and a weight-average molecular weight (Mw) to number-average molecular weight (Mn) ratio Mw/Mn of 1 to 10. Furthermore, it is more preferable that the weight-average molecular weight (Mw) is 5,000 to 15,000, the number-average molecular weight (Mn) is 2,000 to 10,000, and the ratio of Mw/Mn is 1 to 5.

The acid value of the crystalline polymer is preferably 5 mgKOH/g or more in order to achieve the desired low-temperature fixability in terms of the affinity between paper and resin. For the preparation of fine particles by the phase transfer emulsification method, the acid value of the crystalline polyester resin is more preferably 7 mgKOH/g or more. In order to improve the hot offsetting property, the acid value of the crystalline polyester resin is preferably 45 mgKOH/g or less.

The absolute value of the difference between the SP value of the release agent and the SP value of the crystalline polyester resin (ASP value) should be less than 1.1 (cal/cm³)^{1/2}. The SP value of the resin can be calculated by the Fedors method from the monomer content at the time of manufacture. If the composition of the resin monomer is unknown, the monomer can be identified by the following method.

### <Calculation and Analysis Method for the Composition Ratio of the Monomers of the Resin in the Toner Constituent>

The amount of monomer composition may be calculated using any method. For example, the mass ratio of the constituent components can be calculated by separating the components from the toner by gel permeation chromatography (GPC), etc., and then adopting the analysis method described below for each of the separated components. In addition, quantitative analysis can be performed by gas chromatography-mass spectrometry at 300° C. using a reaction reagent (10% tetramethyl ammonium hydroxide (TMAH)/Methanol solution) to methylate the ester bond in the resin structure by soft decomposition, estimating the main constituents, and drawing a calibration curve of TICC intensity.

Separation of each component by GPC can be performed, for example, by the following method: In a GPC measurement using THF (tetrahydrofuran) as the mobile phase, the eluate is divided by a fraction collector or the like, and the fractions corresponding to the desired molecular weight portion of the overall integral of the elution curve are combined. After concentrating and drying the eluate using an evaporator, the solid fraction is dissolved in a heavy solvent such as heavy chloroform or heavy THF, and 1H-NMR measurement is performed to calculate the monomer ratio of the resin in the eluted component from the integral ratio of each element. As another method, the eluate is concentrated, hydrolyzed with sodium hydroxide, etc., and the degradation products are subjected to qualitative and quantitative analysis by high-performance liquid chromatography (HPLC), etc. The constituent monomer ratio is calculated.

e. Fusing Step

the resulting agglomerated particles are then fused by heat treatment to reduce irregularities. The fusion may be accomplished by heating the dispersion of the agglomerated particles while stirring the dispersion of the colored agglomerated particles. Preferably, the temperature of the liquid is around the temperature exceeding the glass transition temperature Tg of the resin being used.

f. Shelling Step

The spherically shaped particles obtained in the fusing step may be shelled to form a shell layer on the surface of the spherically shaped particles. As a method of forming the shell layer, for example, after spherically shaped particles of the desired particle size are produced in the fusing step, an amorphous resin is added and the agglomeration and fusing step is repeated to form a shell layer on the spherically shaped particles obtained in the fusing step.

g. Annealing Step

When crystalline resin is added, the crystalline resin and the amorphous resin are phase separated by annealing after drying, thereby improving fixing property. Specifically, the product should be stored at a temperature around Tg for at least 10 hours.

h. Washing and Drying Steps

Since the resulting dispersion liquid obtained by the above-described steps contains a sub-material such as agglomerated salt in addition to the toner particles, washing is performed in order to remove only the toner particles from the dispersion liquid.

Methods for washing toner particles include a centrifugal separation method, a reduced-pressure filtration method, and a filter press method.

Methods of washing the toner particles include a centrifugal separation method, a reduced-pressure filtration method, and a filter press method. The methods of washing the toner particles are not particularly limited in the present embodiment. A cake body of the colored resin particles can be obtained by either method. If the toner particles cannot be sufficiently washed in a single operation, the cake obtained can be dispersed in an aqueous solvent again to make a slurry, and the step of removing the toner particles by either of the above methods can be repeated. If the washing is performed by a reduced-pressure filtration or filter press method, an aqueous solvent may be used to penetrate the cake and wash away the secondary materials contained in the resin particles.

As the aqueous medium used for this washing, water or a mixture of water and an alcohol such as methanol or ethanol are used. Water is preferably used in view of reducing cost and environmental load caused by, for example, drainage treatment.

Since the washed toner particles contain a large amount of aqueous medium, the colored agglomerated particles only can be obtained by drying and removing the aqueous medium. As the drying method, a dryer such as a spray dryer, a vacuum freeze dryer, a reduced-pressure dryer, a static dryer, a mobile dryer, a fluidized dryer, a rotary dryer, a stirred dryer, or the like, can be used.

The dried toner particles are preferably dried until the final water content is less than 1%. If the toner particles after drying are agglomerated and impractical for use, the agglomerated particles may be pulverized using a device such as a jet mill, a Henschel mixer, a super mixer, a coffee mill, an Oster blender, or a hood processor to break up the agglomerated particles.

i. External Additive Step

The toner particles obtained by the present disclosure may be added to or mixed with the organic fine particles, polymer-based fine particles, cleaning aids, or the like to provide fluidity, electrification, cleaning properties, or the like. Specific mixing means include a method of impacting the mixture with a high-speed rotating blade and a method of injecting the mixture into the high-speed air stream, accelerating it, and bombarding the appropriate impingement plates with particles or complexed particles. Equipments include an Angmill (manufactured by Hosokawa Micron Co., Ltd.) and an I-type mill (manufactured by Nippon Pneumatic Co., Ltd.) modified to reduce the grinding air pressure, a hybridization system (manufactured by Nara Machinery Works, Ltd.), a crypton system (manufactured by Kawasaki Heavy Industries, Ltd.), and an automatic mortar.

### External Additive

The average particle size of the primary particles of the inorganic fine particles is preferably 5 nm to 2 μm and more preferably 5 nm to 500 nm.

The specific surface area of the inorganic fine particles by the BET method is preferably 20 m²/g to 500 m²/g.

The content of the inorganic fine particles to be used is preferably 0.01% by mass to 5% by mass of the resin particles.

Examples of the inorganic fine particles include silica, alumina, titanium oxide, barium titanate, magnesium titanate, calcium titanate, strontium titanate, zinc oxide, tin oxide, silica sand, clay, mica, silica limestone, diatomaceous earth, chromium oxide, cerium oxide, bengala, antimony trioxide, magnesium oxide, zirconium oxide, barium sulfate, barium carbonate, calcium carbonate, silicon carbide, silicon nitride, or the like.

Examples of the polymer-based fine particles include polystyrene obtained by soap-free emulsion polymerization, suspension polymerization, and dispersion polymerization, polycondensation based particles such as methacrylic acid ester, acrylic acid ester copolymer, silicone, benzoguanamine, and nylon, and polymer particles made of thermosetting resin.

Such fluidizing agents can be surface treated to increase hydrophobicity and prevent deterioration of flowability and charging characteristics even under high humidity conditions.

Examples of surface treating agents include silane coupling agents, silanizing agents, silane coupling agents having fluoroalkyl groups, organotitanate-based coupling agents, aluminum-based coupling agents, silicon oils, modified silicon oils, and the like.

Examples of the cleaning improvement agent to remove the developer remaining in the photosensitive element or the primary transfer medium include a fatty acid metal salt such as zinc stearate, calcium stearate, or stearic acid; a polymer fine particle manufactured by soap-free emulsion polymerization, such as polymethylmethacrylate fine particles, polystyrene fine particles, or the like.

Preferably, the polymer fine particles have a relatively narrow particle size distribution and have a volume average particle diameter of 0.01 μm to 1 μm.

### Toner Storage Unit

The toner storage unit or storage of one embodiment of the present disclosure includes a unit configured to store a toner, and the toner of the present disclosure, where the toner is stored in the unit. Examples of an embodiment of the toner storage unit include a toner storage container, a developing device, and a process cartridge.

The toner storage container includes a container in which the toner is stored. The developing device is a unit that contains the toner and is configured to develop an electrostatic latent image with the toner.

### Process Cartridge

A process cartridge discussed in connection with one embodiment of the present disclosure is configured so that the process cartridge is detachably mounted in various image forming apparatuses. The process cartridge includes at least a photoconductor configured to bear an electrostatic latent image, and a developing unit configured to develop the electrostatic latent image borne on the photoconductor with the developer of the present disclosure to form a toner image (may be also referred to as a “visible image”). The process cartridge of the present disclosure may further include other units according to the necessity.

The developing unit includes a developer storage unit in which the developer of the present disclosure is stored, and a developer bearing member configured to bear the developer, which is stored in the developer storage unit, on a surface of the developer bearing member and to transport the developer. The developing unit may further include a regulating member configured to regulate a thickness of a layer of the developer borne on the developer bearing member.

When the toner storage unit is mounted in an image forming apparatus and images are formed by such an image forming apparatus, high-quality and highly-precise images are stably formed over a long period taking advantage of the characteristics of the toner that can achieve excellent hot-offset resistance, charging stability, stress resistance, and background-deposition resistance.

### Image Forming Apparatus and Image Forming Method

The image forming apparatus of the present disclosure includes at least an electrostatic latent image bearer, an electrostatic latent image forming unit, and a developing unit. The image forming apparatus may further include other units according to the necessity.

The image forming method discussed in connection with the present disclosure includes at least forming an electrostatic latent image, and developing. The image forming method may further include other steps according to the necessity.

The image forming method is suitably performed by the image forming apparatus. The forming an electrostatic latent image is suitably performed by the electrostatic latent image forming unit. The developing is suitably performed by the developing unit. The above-mentioned other steps may be suitably performed by the above-mentioned other units.

The image forming apparatus of the present disclosure more preferably includes an electrostatic latent image bearer, an electrostatic image forming unit configured to form an electrostatic latent image on the electrostatic latent image bearer, a developing unit that stores a toner and is configured to develop the electrostatic latent image formed on the electrostatic latent image bearer with the toner to form a toner image, a transferring unit configured to transfer the toner image formed on the electrostatic latent image bearer to a surface of a recording medium, and a fixing unit configured to fix the toner image transferred on the surface of the recording medium. Moreover, the image forming method of the present disclosure more preferably includes forming an electrostatic latent image on an electrostatic latent image bearer, developing the electrostatic latent image formed on the electrostatic latent image bearer with a toner to form a toner image, transferring the toner image formed on the electrostatic latent image bearer to a surface of a recording medium, and fixing the toner image transferred to the surface of the recording medium.

The toner is used in the developing unit. Preferably, a developer including the toner and optionally other components, such as a carrier, is used in the developing unit to form the above-described toner image.

### Electrostatic Latent Image Bearer

A material, structure, and size of the electrostatic latent image bearer (may be also referred to as a “photoconductor”) are not particularly limited, and may be appropriately selected from those known in the art. Examples of the material of the electrostatic latent image bearer include inorganic photoconductors (e.g., amorphous silicon, and selenium), and organic photoconductors (e.g., polysilane, and phthalo polymethine).

### Electrostatic Latent Image Forming Unit

The electrostatic latent image forming unit or the electrostatic latent image former is not particularly limited, provided that the electrostatic latent image forming unit is a unit configured to form an electrostatic latent image on the electrostatic latent image bearer. The electrostatic latent image forming unit may be appropriately selected in accordance with the intended purpose. Examples of the electrostatic latent image forming unit include a unit including a charging member configured to charge a surface of the electrostatic latent image bearer, and an exposing member configured to expose the charged surface of the electrostatic latent image bearer to light to correspond to an image to be formed.

### Developing Unit

The developing unit or developer is not particularly limited, provided that the developing unit stores a toner and is configured to develop the electrostatic latent image formed on the electrostatic latent image bearer with the toner to form a visible image. The developing unit may be appropriately selected in accordance with the intended purpose.

### Cleaning Unit

The image forming apparatus of the present disclosure preferably further includes a cleaning unit or cleaner.

As described above, the toner of the present disclosure has excellent cleaning properties.

Therefore, cleaning properties are improved further by using the toner in the image forming apparatus including the cleaning unit, as described below.
Even when stress is applied to the toner, flowability of the toner is maintained owing to an improved effect of the toner base particles as a spacer, consequently improving cleaning properties.
An adequate amount of the external additive (e.g., the zinc stearate particles) is released from the toner on the photoconductor to form a deposited layer (i.e., a dam layer) of the external additive at a nip with a cleaning blade, consequently achieving excellent cleaning properties.

The cleaning unit is not particularly limited, provided that the cleaning unit is a unit capable of removing the residual toner on the photoconductor. The cleaning unit may be appropriately selected in accordance with the intended purpose. Examples of the cleaning unit include a magnetic brush cleaner, an electrostatic brush cleaner, a magnetic roller cleaner, a blade cleaner, a brush cleaner, and a web cleaner.

### <Other Units>

Examples of the above-mentioned other units include a transferring unit, a fixing unit, a charge-eliminating unit, a recycling unit, and a controlling unit.

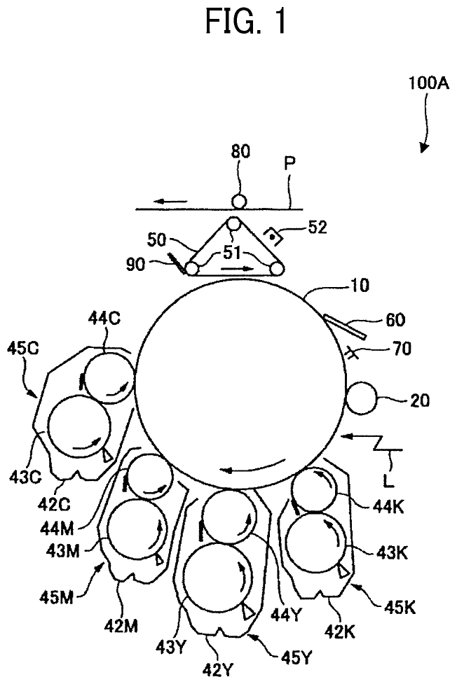

Next, one embodiment for carrying out a method of forming an image using the image forming apparatus of the present disclosure will be described with reference to FIG. 1.

FIG. 1 illustrates an example of the image forming apparatus of one embodiment of the present disclosure. A color image forming apparatus 100A of FIG. 1 includes a photoconductor drum 10 (may be referred to as a “photoconductor 10” hereinafter) serving as the electrostatic latent image bearer, a charging roller 20 serving as the charging unit, an exposure device 30 serving as the exposing unit, a developing device 40 serving as the developing unit, an intermediate transfer member 50, a cleaning device 60 serving as the cleaning unit having a cleaning blade, and a charge-eliminating lamp 70 serving as the charge-eliminating unit.

The intermediate transfer member 50 is an endless belt, and is rotatably driven by three rollers 51 in the direction indicated with an arrow in FIG. 1. The three rollers 51 are disposed inside the loop of the endless belt to support the endless belt. Some of the three rollers 51 may also function as a transfer bias roller capable of applying predetermined transfer bias (or primary transfer bias) to the intermediate transfer member 50. The cleaning device 90 including the cleaning blade is disposed closely to the intermediate transfer member 50. Moreover, the transfer roller 80 is disposed closely to the intermediate transfer member 50 in a manner that the transfer roller 80 faces the intermediate transfer member 50. The transfer roller serves as the transferring unit capable of applying transfer bias for transferring (or secondary transferring) the developed image (also referred to as the visible image or the toner image) to transfer paper P serving as the recording medium. The corona charger 52 configured to apply charge to the toner image on the intermediate transfer member 50 is disposed at the periphery of the intermediate transfer member 50. The position of the corona charger 52 is located between a contact area (a) and a contact area (b) relative to the rotational direction of the intermediate transfer member 50, the contact area (a) being a contact area between a photoconductor 10 and the intermediate transfer member 50, and the contact area (b) being a contact area between the intermediate transfer member 50 and the transfer paper P.

A black developing unit 45K, a yellow developing unit 45Y, a magenta developing unit 45M, and a cyan developing unit 45C are disposed at the periphery of the photoconductor drum 10 to directly face the photoconductor drum 10. The black developing unit 45K includes a developer storage unit 42K, a developer supply roller 43K, and a developing roller 44K. The yellow developing unit 45Y includes a developer storage unit 42Y, a developer supply roller 43Y, and a developing roller 44Y. The magenta developing unit 45M includes a developer storage unit 42M, a developer supply roller 43M, and a developing roller 44M. The cyan developing unit 45C includes a developer storage unit 42C, a developer supply roller 43C, and a developing roller 44C. Moreover, the developing belt 41 is an endless belt rotatably supported by two or more belt rollers. Part of the developing belt 41 comes into contact with the electrostatic latent image bearer 10.

In the color image forming apparatus 100A of FIG. 1, for example, the charging roller 20 uniformly charges a surface of the photoconductor drum 10. The exposure device 30 exposes the charged surface of the photoconductor drum 10 to light to correspond to an image to be formed to form an electrostatic latent image. The toner is supplied from the developing device 40 to develop the electrostatic latent image formed on the photoconductor drum 10 to form a toner image. Voltage is applied from the roller 51 to the toner image to transfer (or primary transfer) the toner image onto the intermediate transfer member 50, followed by transferring (or secondary transferring) onto transfer paper P. As a result, the transferred image is formed on the transfer paper P. The residual toner on the photoconductor 10 is removed by the cleaning device 60. The residual charge of the photoconductor 10 is temporarily removed by the charge-eliminating lamp 70.

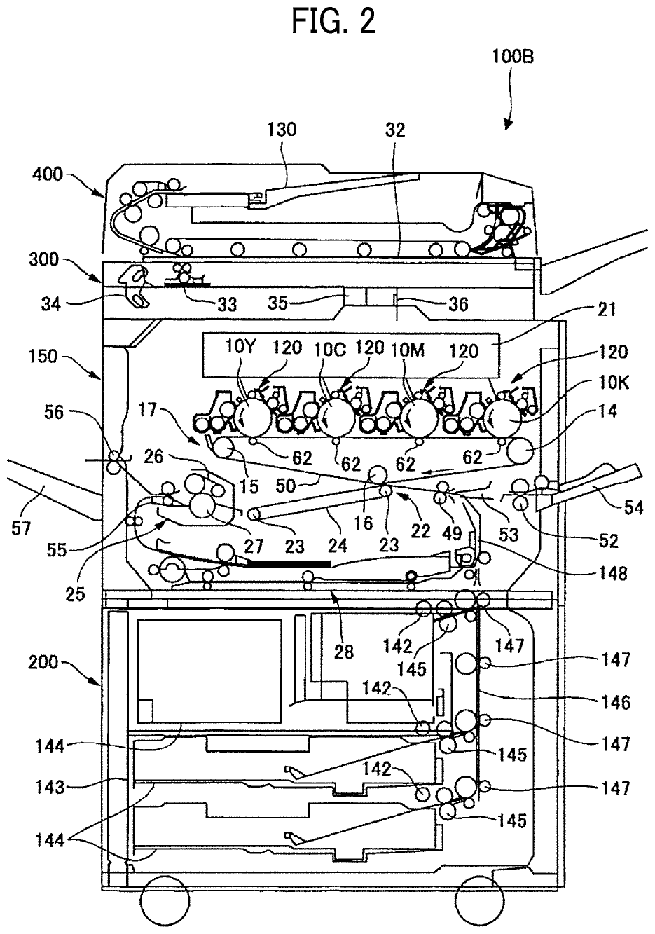

FIG. 2 illustrates another example of the image forming apparatus of the present disclosure. The image forming apparatus 100B of FIG. 2 includes a photocopier main body 150, a paper feeding table 200, a scanner 300, and an automatic document feeder (ADF)400.

An intermediate transfer member 50, which is an endless belt, is disposed at the central part of the photocopier main body 150. The intermediate transfer member 50 is supported by support rollers 14, 15, and 16, and is rotatably disposed in the clockwise direction in FIG. 2. An intermediate transfer member cleaning device 17 is disposed closely to the support roller 15. The intermediate transfer member cleaning device 17 is configured to remove the residual toner on the intermediate transfer member 50. A tandem developing device 120 is disposed to face the section of the intermediate transfer member 50 supported by the support rollers 14 and 15. In the tandem developing device 120, four image forming units 120, i.e., a yellow image forming unit, a cyan image forming unit, a magenta image forming unit, and a black image forming units, are arranged in series along the travelling direction of the intermediate transfer member 50. An exposure device 21 serving as the exposing member is disposed closely to the tandem developing device 120. A secondary transfer device 22 is disposed to the side of the intermediate transfer member 50 opposite to the side where the tandem developing device 120 is disposed. The secondary transfer device 22 includes a secondary transfer belt 24. The secondary transfer belt 24 is an endless belt and is supported by a pair of rollers 23. Transfer paper borne on and transported by the secondary transfer belt 24 comes into contact with the intermediate transfer member 50. A fixing device 25 serving as the fixing member is disposed closely to the secondary transfer device 22. The fixing device 25 includes a fixing belt 26, which is an endless belt, and a press roller 27 disposed to press against the fixing belt 26.

The tandem image forming apparatus includes a sheet reverser 28 disposed closely to the secondary transfer device 22 and to the fixing device 25. The sheet reverser 28 is configured to reverse transfer paper to perform image formation on both sides of the transfer paper.

Next, formation of a full-color image (i.e., a color copy) using the tandem developing device 120 will be described. First, a document is set on a document table 130 of the automatic document feeder (ADF) 400. Alternatively, a document is set on contact glass 32 of a scanner 300 by opening the automatic document feeder 400. Once the document is set, the automatic document feeder 400 is closed.

Once start switch (not illustrated) is pressed, if the document is set on the automatic document feeder 400, the document is transported onto the contact glass 32, then the scanner 300 is driven. If the document is initially set on the contact glass 32, the scanner 300 is immediately driven once the start switch is pressed. Then, a first carriage 33 and a second carriage 34 are driven to scan the document. During the scanning, the first carriage 33 irradiates a surface of the document with light emitted from a light source, the light reflected from the surface of the document is again reflected by a mirror of the second carriage 34 to pass through an imaging forming lens 35. The light is then received by a reading sensor 36 to read the color document (e.g., the color image) to acquire image information of black, yellow, magenta, and cyan.

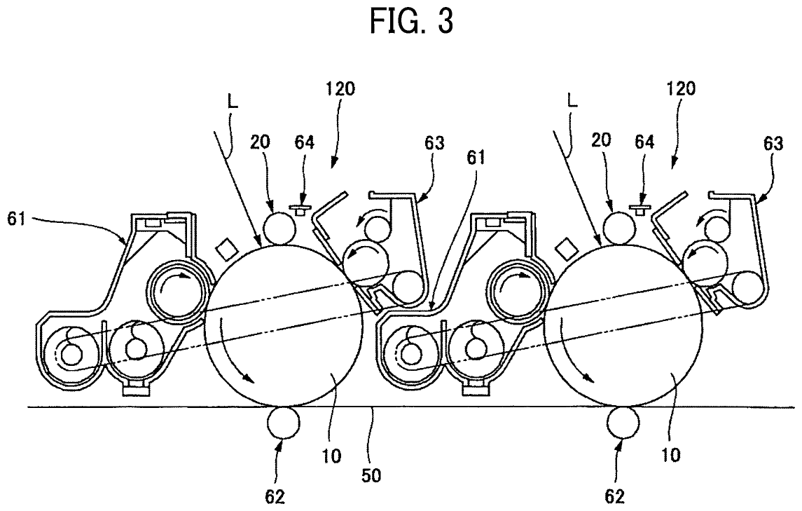

The image information of each of black, yellow, magenta, and cyan is transmitted to the corresponding image forming unit 120 (the black image forming unit, the yellow image forming unit, the magenta image forming unit, or the cyan image forming unit) of the tandem developing device 120. By means of each image forming unit, a toner image of each color (black, yellow, magenta, or cyan) is formed. Specifically, as illustrated in FIG. 3, each image forming unit 120 (the black image forming unit, the yellow image forming unit, the magenta image forming unit, or the cyan image forming unit) of the tandem developing device 120 includes: an electrostatic latent image bearer 10 (a black electrostatic latent image bearer 10K, a yellow electrostatic latent image bearer 10Y, a magenta electrostatic latent image bearer 10M, or a cyan electrostatic latent image bearer 10C); a charging device 20 that is the charging device configured to uniformly charge a surface of the electrostatic latent image bearer 10; an exposure device configured to expose the electrostatic latent image bearer to light (L in FIG. 3) to correspond to each color image based on the corresponding color image information, to thereby form an electrostatic latent image corresponding to each color image on the electrostatic latent image bearer; a developing device 61 configured to develop the electrostatic latent image with the corresponding color toner (the black toner, the yellow toner, the magenta toner, or the cyan toner), to thereby form a toner image of the corresponding color toner; a transfer charger 62 configured to transfer the toner image to an intermediate transfer member 50; a cleaning device 63; and a charge-eliminating unit 64. Each image forming unit 120 can form an image of a single color (e.g., a black image, a yellow image, a magenta image, and a cyan image) based on the corresponding color image information. The black image formed on the black electrostatic latent image bearer 10K, the yellow image formed on the yellow electrostatic latent image bearer 10Y, the magenta image formed on the magenta electrostatic latent image bearer 10M, and the cyan image formed on the cyan electrostatic latent image bearer 10C in the above-described manner are sequentially transferred (or primary transferred) onto the intermediate transfer member 50 that is rotatably supported by the support rollers 14, 15, and 16. The black image, the yellow image, the magenta image, and the cyan image are superimposed on the intermediate transfer member 50 to form a composite color image (i.e., a transferred color image).

In the paper feeding table 200, meanwhile, one of paper feeding rollers 142 is selectively driven to rotate to feed sheets (i.e., recording paper) from one of paper feeding cassettes 144 stacked in a paper bank 143. The sheets are separated one by one by a separation roller 145 to feed each sheet into a paper feeding path 146, and the fed sheet is transported by a transport roller 147 to guide the sheet into a paper feeding path 148 inside the photocopier main body 150. The sheet is then let collide with a registration roller 49 to stop. Alternatively, a paper feeding roller 142 is driven to rotate to feed sheets (i.e., recording paper) on a manual feed tray 54, the sheets are separated and fed into a manual paper feeding path 53 one by one with a separation roller 52. Similarly, the fed sheet is let collide with a registration roller 49 to stop. The registration roller 49 is typically earthed during use, but the registration roller 49 may be used in the state where bias is applied to the registration roller 49 for removing paper dusts from sheets. Synchronizing with the timing of the composite color image (i.e., the transferred color image) formed on the intermediate transfer member 50, the registration roller 49 is driven to rotate to feed the sheet (i.e., the recording paper) between the intermediate transfer member 50 and the secondary transfer device 22. The composite color image (i.e., the transferred color image) is then transferred (or secondary transferred) onto the sheet (i.e., the recording paper) by the secondary transfer device 22. In the manner as described above, the color image is transferred and formed onto the sheet (i.e., the recording paper). After transferring the image, the residual toner on the intermediate transfer member 50 is cleaned by the intermediate transfer member cleaning device 17.

The sheet (i.e., the recording paper) on which the color image has been transferred is transported by the secondary transfer device 22 to send the sheet to the fixing device 25. By means of the fixing device 25, heat and pressure are applied to the composite color image (i.e., the transferred color image) to fix the composite color image to the sheet (i.e., the recording paper). Thereafter, the traveling direction of the sheet (i.e., the recording paper) is switched by the switching claw 55 to eject the sheet (i.e., the recording paper) with an ejection roller 56 to stack the sheet (i.e., the recording paper) on the paper ejection tray 57. Alternatively, the traveling direction of the sheet (i.e., the recording paper) is switched by the switching claw 55 and the sheet is flipped by the sheet reverser 28 to send the sheet back to the transfer position. After recording an image also on the back side of the sheet, the sheet is ejected by the ejection roller 56 to stack on the paper ejection tray 57.

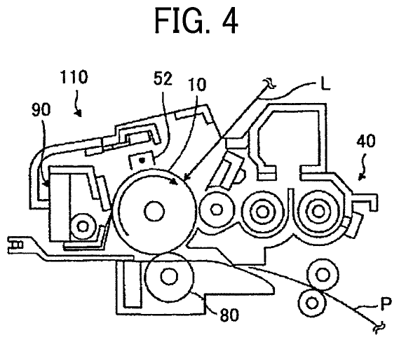

FIG. 4 illustrates an example of the process cartridge discussed in connection with the present disclosure. The process cartridge 110 includes a photoconductor drum 10, a corona discharger 52, a developing device 40, a transfer roller 80, and a cleaning device 90.

### Examples

The present disclosure will be described below by way of Examples. The present disclosure should not be construed as being limited to these Examples. In Examples, “part(s)” denotes “part(s) by mass” and “%” denotes “% by mass” unless otherwise stated.”

### Example 1

### (Preparation of Polyester Resin 1)

In a reaction vessel equipped with a cooling tube, an agitator, and a nitrogen introduction tube, 2 mol ethylene oxide adduct of bisphenol A/3 mol propylene oxide adduct of bisphenol A (molar ratio: 40/60) as a diol component, terephthalic acid/adipic acid (molar ratio: 85/15) as a dicarboxylic acid component and 3.5 mol % trimethylolpropane relative to the total monomer content were charged so that the molar ratio of hydroxyl group to carboxylic acid (OH/COOH) was to be 1.2. In addition, 1,000 ppm of tetrabutyl orthotitanate relative to the total monomer content was added as a condensation catalyst, heated up to 230° C. over 2 hours under nitrogen gas flow and distilling off the water produced, and the reaction was carried out for 5 hours. Then, the mixture was reacted under a reduced pressure of 5 mmHg to 15 mmHg for 4 hours, cooled to 180° C. 1.0 mol % of trimellitic anhydride with respect to the total monomer amount and 200 ppm of tetrabutyl orthotitanate with respect to the total monomer amount were added to the reaction vessel, and the mixture was reacted at 180° C. for 1 hour under normal pressure, and further reacted under a reduced pressure of 5 mmHg to 20 mmHg for 3 hours to obtain [polyester resin 1] which has a glass transition temperature of 57° C. and average molecular weight of 7,700 as determined from the DSC curve of the first warming by DSC.

### (Preparation of Prepolymer 1)

In a reaction vessel equipped with a cooling tube, an agitator, and a nitrogen introduction tube, 3-methyl-1,5-pentanediol as adiol component, terephthalic acid/adipic acid (molar ratio 55/45) as a dicarboxylic acid component, trimethylolpropane (1.0 mol % of the total monomer content), and 0.5 mol % trimellitic anhydride relative to the total monomer content were charged so that the molar ratio of hydroxyl group to carboxylic acid (OH/COOH) was to be 1.5. In addition, 1,000 ppm of tetrabutyl orthotitanate relative to the total monomer content was added as a condensation catalyst, heated up to 200° C. over 2 hours under nitrogen gas flow and then heated up to 230° C. over 2 hours distilling off the water produced, and the reaction was carried out for 3 hours while. Then, the mixture was reacted under a reduced pressure of 5 mmHg to 15 mmHg for 5 hours, to obtain [intermediate polyester 1] which has an average molecular weight of 18,000.

Then, in a reaction vessel equipped with a cooling tube, an agitator, and a nitrogen introduction tube, [Intermediate Polyester 1] and isophorone diisocyanate (IPDI) were charged so that the molar ratio of the isocyanate group of IPDI and the hydroxyl group of [Intermediate Polyester 1] (NCO/OH) to be 2.0, then ethyl acetate was added so that the solution to be a 50% ethyl acetate solution. The temperature was then heated up to 80° C. under nitrogen gas flow and reacted for 5 hours to obtain an ethyl acetate solution of [prepolymer 1], which is a reactive precursor of polyester resin (A). The glass transition temperature of the obtained amine elongated product of [prepolymer 1] was −37° C. as determined from the DSC curve of the first temperature increase by DSC.

Ethyl acetate was added to the ethyl acetate solution of [prepolymer 1] so that [prepolymer 1] to be 20% ethyl acetate solution, an 20% ethyl acetate solution of isophorone diamine (IPDA) was added dropwise with stirring so that a molar ratio of isocyanate group of [prepolymer 1] to the amino group of IPDA (NH2/NCO), and stirred thoroughly. . . . The resulting ethyl acetate solution was cast on a Teflon (registered trademark) Petri dish, dried at 80° C. for 10 hours, and further dried under reduced pressure at 120° C. and under 10 kPa to remove solvent sufficiently to obtain an amine elongated [prepolymer 1].

### (Preparation of Crystalline Polyester Resin Dispersion Liquid C-1)

### <Synthesis of Crystalline Polyester Resin C-1>

In a 5 L four-neck flask equipped with a nitrogen introduction tube, a dehydration tube, an agitator, and a heat exchanger, 1,6-hexanediol and sebacic acid were charged so that the ratio of OH group to COOH group (OH/COOH) to be 1.1. The reaction was carried out with water flowing out, along with 500 ppm titanium tetraisopropoxide relative to the mass of the raw materials prepared, and the temperature was finally heated up to 235° C. and reacted for 1 hour. The reaction was then carried out under reduced pressure of less than 10 mmHg for 6 hours. The temperature was then set to 185° C., anhydrous trimellitic acid was added so that the molar ratio to COOH group to be 0.053, and the reaction was carried out for 2 hours with stirring to obtain [crystalline polyester resin C-1].

In a four-necked flask, [crystalline polyester resin C-1] (55 parts), methyl ethyl ketone (35 parts), and 2-propyl alcohol (10 parts) was added. The mixture was then stirred while heating at the melting point temperature of [crystalline polyester resin C-1] to dissolve the above [crystalline polyester resin C-1]. The SP value of [crystalline polyester resin C-1] was 10.2 (cal/cm³)^{1/2}.

### <Preparation of Crystalline Polyester Resin Dispersion Liquid C-1>

In a vessel equipped with an agitator and thermometer, 45 parts of [crystalline polyester resin C-1] and 450 parts of ethyl acetate are added, and the temperature is heated up to 80° C. with stirring. The dispersion is then carried out using a bead mill (Ultra Viscomyl, Imex) at a feed rate of 1 kg/hr, a disk peripheral speed of 6 m/sec, 80% by volume of 0.5 mm diameter zirconia beads, and 3 passes to obtain [crystalline polyester resin dispersion liquid C-1]. The volume average particle diameter of the obtained crystalline polyester resin particles is 450 nm, and the solid concentration of the resin particles is 10%. The melting point of [crystalline polyester resin C-1] is 74.9° C., and the SP value is 10.2 (cal/cm³)^{1/2}.

### <Synthesis of Crystalline Polyester Resin C-2>

In a 5 L quart flask equipped with a nitrogen inlet pipe, a dehydration pipe, an agitator, and a heat transfer tube, thylene glycol and sebacic acid were charged so that the ratio of OH to COOH groups (OH/COOH) to be 1.1. The reaction was carried out with water flowing out, along with 500 ppm of titanium tetraisopropoxide relative to the mass of the raw materials prepared, and the temperature was finally heated up to 235° C. and allowed to react for 1 hour. The reaction was then carried out under reduced pressure of less than 10 mmHg for 6 hours. The temperature was then set to 185° C., anhydrous trimellitic acid was added so that the molar ratio to COOH group to be 0.053, and the reaction was carried out for 2 hours with stirring to obtain [crystalline polyester resin C-2].

In a four-necked flask, [crystalline polyester resin C-2] (55 parts), methyl ethyl ketone (35 parts), and 2-propyl alcohol (10 parts) were added. The mixture was then stirred while heating at the melting point temperature of [crystalline polyester resin C-2] to dissolve the above [crystalline polyester resin C-2].

The SP value of [crystalline polyester resin C-2] was 10.0 (cal/cm³)^{1/2}.

### <Synthesis of Crystalline Polyester Resin C-3>

In a 5 L quart flask equipped with a nitrogen introduction tube, a dehydration pipe, an agitator, and a heat transfer tube, 1,6-hexanediol and 1,10-decanedicarboxylic acid were charged so that the ratio of OH to COOH groups (OH/COOH) to be 1.1. The reaction was carried out with water flowing out along with 500 ppm titanium tetraisopropoxide relative to the mass of the raw materials prepared, and the temperature was finally raised to 235° C. and allowed to react for 1 hour. The reaction was then carried out under reduced pressure of less than 10 mmHg for 6 hours. The temperature was then set to 185° C., anhydrous trimellitic acid was added so that the molar ratio to the COOH group was 0.053, and the reaction was carried out for 2 hours with stirring to obtain [crystalline polyester resin C-3].

In a four-necked flask, [crystalline polyester resin C-3] (55 parts), methyl ethyl ketone (35 parts), and 2-propyl alcohol (10 parts) were added. The mixture was then stirred while heating at the melting point temperature of [crystalline polyester resin C-3] to dissolve the above [crystalline polyester resin C-3]. The SP value of [crystalline polyester resin C-3] was 9.7 (cal/cm³)^{1/2}.

### <Synthesis of Crystalline Polyester Resin C-4>

In a 5 L four-neck flask equipped with a nitrogen introduction tube, a dehydration pipe, an agitator, and heat transfer tube, ethylene glycol and adipic acid were charged so that the ratio of OH groups to COOH groups (OH/COOH) to be 1.1. The reaction was carried out while allowing water flowing out, along with titanium tetraisopropoxide at 500 ppm relative to the mass of the raw materials prepared, and the temperature was finally heated up to 235° C. and allowed to react for 1 hour. The reaction was then carried out under reduced pressure of less than 10 mmHg for 6 hours. The temperature was then set to 185° C., anhydrous trimellitic acid was added so that the molar ratio to the COOH group was 0.053, and the reaction was carried out for 2 hours with stirring to obtain [crystalline polyester resin C-4].

In a four-necked flask, [crystalline polyester resin C-4] (55 parts), methyl ethyl ketone (35 parts), and 2-propyl alcohol (10 parts) were added. The mixture was then stirred while heating at the melting point temperature of [crystalline polyester resin C-4] to dissolve the above [crystalline polyester resin C-4]. [The SP value of [crystalline polyester resin C-4] was 10.9 (cal/cm³)^{1/2}.

### <Synthesis of Crystalline Polyester Resin C-5>

In a 5 L quart flask equipped with a nitrogen introduction tube, a dehydration tube, an agitator, and a heat transfer tube, 1,6-hexanediol and sebacic acid were charged so that the ratio of OH to COOH groups (OH/COOH) to be 1.1. The reaction was carried out with water flowing out along with 500 ppm titanium tetraisopropoxide relative to the mass of the raw materials prepared, and the temperature was finally heated up to 235° C. and allowed to react for 1 hour. The reaction was then carried out under reduced pressure of less than 10 mmHg for 6 hours. The temperature was then set to 185° C., anhydrous trimellitic acid was added so that the molar ratio to the COOH group to be 0.053, and the reaction was carried out for 2 hours with stirring to obtain [crystalline polyester resin C-5].

In a four-necked flask, [crystalline polyester resin C-5] (55 parts), methyl ethyl ketone (35 parts), and 2-propyl alcohol (10 parts) were added. The mixture was then stirred while heating at the melting point temperature of [crystalline polyester resin C-5] to dissolve the above [crystalline polyester resin C-5]. The SP value of [crystalline polyester resin C-5] was 9.8 (cal/cm³)^{1/2}.

### <Synthesis of Crystalline Polyester Resin C-6>

In a 5 L quart flask equipped with a nitrogen introduction tube, a dehydration tube, an agitator, and a heat transfer tube, 1,6-hexanediol and oxalic acid were charged so that the ratio of OH groups to COOH groups (OH/COOH) to be 1.1. The reaction was carried out while water was drained out along with 500 ppm titanium tetraisopropoxide relative to the mass of the raw materials prepared, and the temperature was finally increased to 235° C. for 1 hour. The reaction was then carried out under reduced pressure of less than 10 mmHg for 6 hours. The temperature was then set to 185° C., anhydrous trimellitic acid was added so that the molar ratio to the COOH group to be 0.053, and the reaction was carried out for 2 hours with stirring to obtain [crystalline polyester resin C-6]. In a four-necked flask, [crystalline polyester resin C-6] (55 parts), methyl ethyl ketone (35 parts), and 2-propyl alcohol (10 parts) were added. The mixture was then stirred while heating at the melting point temperature of [crystalline polyester resin C-6] to dissolve the above [crystalline polyester resin C-6]. The SP value of [crystalline polyester resin C-6] was 10.8 (cal/cm³)^{1/2}.

### <Synthesis of Amorphous Polyester Resin MB for Master Batch>

In a four-neck flask equipped with a nitrogen introduction tube, a dehydration tube, an agitator, and heat transfer tube, bisphenol A-ethylene oxide 2 mol adduct, bisphenol A-propylene oxide 2 mol adduct, terephthalic acid, and adipic acid were charged so that a molar ratio of bisphenol A propylene oxide 2 mol adduct to bisphenol A ethylene oxide 2 mol adduct (bisphenol A propylene oxide 2 mol adduct/bisphenol A ethylene oxide 2 mol adduct) to be 60/40, a molar ratio of terephthalic acid and adipic acid (terephthalic acid/adipic acid) to be 97/3, and a molar ratio of hydroxyl group and carboxyl (OH/COOH) to be 1.3. The reaction is carried out with titanium tetraisopropoxide (500 ppm relative to the resin component) at 230° C. for 8 hours at normal pressure, and then at reduced pressure of 10 mmHg to 15 mmHg for 4 hours. Then anhydrous trimellitic acid was added to the reaction vessel so that a concentration to the total resin component to be 1 mol %, and reacted at 180° C. at normal pressure for 4 hours to obtain [amorphous polyester resin MB for masterbatches].

### <Preparation of Master Batch 1>

1,200 parts of water, 500 parts of carbon black (Printex 35, Dexa, Inc.) [DBP oil absorption amount=42 mL/100 mg, pH=9.5], and 500 parts of amorphous polyester resin MB for Master Batch were mixed with a Henschel mixer (Japan Coke Industry Co., Ltd.), the mixture was kneaded using two rolls at 150° C. for 30 minutes, then rolled and cooled, pulverized with a pulverizer to obtain [Master Batch 1].

### (Preparation of WAX Dispersion Liquid 1)

180 parts of ester wax (WE-11, synthetic wax of plant-derived monomer, melting point 67. degree.sC_) and 17 parts of anionic surfactant (Daiichi Kogyo Pharmaceutical Co., Ltd., Neogen SC, sodium dodecylbenzene sulfonate) were added to 720 parts of ion-exchanged water. The mixture was dispersed using a homogenizer while heating to 90° C. to obtain [WAX dispersion liquid 1]. The resulting wax particles had a volume average particle size of 300 nm and a solids concentration of 25% of the resin particles.

The SP value for the ester wax was 9.5 (cal/cm³)^{1/2}.

### (Preparation of WAX Dispersion Liquid 2)

In the preparation of the WAX dispersion liquid 1, the ester wax (manufactured by Nisshin Oil Co., Ltd., WE-11, melting point 67° C.) was replaced with ester wax (manufactured by Nisshin Oil Co., Ltd., WE-10, melting point 70.4° C.) to obtain [WAX dispersion liquid 2].

The SP value for the ester wax was 9.7 (cal/cm³)^{1/2}.

### <Preparation of Toner>

### <Preparation of Oil Phase>

50 parts of [Amine elongated prepolymer 1], 50 parts of [crystalline polyester resin dispersion liquid C-1], 50 parts of [WAX dispersion liquid 1], 550 parts of [Polyester resin 1], and 100 parts of Master Batch 1 were placed in a container and mixed with a TK homomixer (manufactured by Primix Co., Ltd.) at 5,000 rpm for 60 minutes to obtain [oil phase 1].

The above blended amount indicates the amount of solids contained in each raw material.

### <Preparation of Aqueous Phase>

990 parts of water, 20 parts of sodium dodecyl sulfate, and 90 parts of ethyl acetate were mixed and stirred to obtain an opalescent liquid, [aqueous phase 1].

### <Emulsification>

700 parts of [Oil phase 1] were stirred with a TK homomixer at 8,000 rpm and 20 parts of 28% ammonia water was added to be neutralization coefficient of 400%. After mixing for 10 minutes, 1,200 parts of [water phase 1] were dropped slowly to obtain [emulsion slurry 1]. The particle size of [emulsion slurry 1] was 0.50 μm. The solids concentration was 23.0%.

### <Agglomeration/Fusing Process>

100 parts of [emulsion slurry 1] and 300 parts of ion-exchanged water are charged in a container and stirred for 1 minute. Next, 100 parts of a solution of 3% magnesium chloride is added dropwise, stirred for another 5 minutes, and then the temperature is heated up to 60° C. When a particle size get 5.0 μm, 50 parts of sodium chloride is added to complete the coagulation process to obtain [Coagulation slurry 1].

The [aggregation slurry 1] was heated to 70° C. while stirring and cooled to 0.957, which was the desired circularity, to obtain [resin particle dispersion 1].

### <Annealing Process, Cleaning and Drying Process>

[Resin particle dispersion liquid 1] was stored at 45° C. for 10 hours, filtered under reduced pressure, and washed and dried as follows.

(1): 100 parts of ion-exchanged water was mixed to the filter cake in a TK homomixer (12,000 rpm for 10 minutes) and filtered.

(2): 900 portions of ion-exchanged water were added to the filter cake in (1), mixed with a TK homomixer under ultrasonic vibration (at 12,000 rpm for 30 minutes), and filtered in vacuo. This procedure was repeated so that the electrical conductivity of the reslurry liquid was 10 μC/cm or less and filtered to yield [filter cake 1].

The [Filtration cake 1] was dried in a circulating air dryer at 45° C. for 48 hours, and sieved through a 75 μm mesh to obtain [resin particle 1].

### <Appendix>

2.5 parts of TS530 (manufactured by Cavozil), which is an inorganic fine particle, was added to 100 parts of [resin particle 1] and mixed with a Henschel mixer at 40 m/s for 10 minutes to obtain [toner 1].

### Example 2

In Example 1, [crystalline polyester resin C-1] was changed to [crystalline polyester resin C-2] and [WAX dispersion liquid 1] was changed to [WAX dispersion liquid 2] in the preparation of [crystalline polyester resin dispersion liquid C-1], and the heating temperature for the agglomerated slurry was changed to 68° C. in the agglomeration and fusion step to obtain [toner 2].

### Example 3

In Example 1, [crystalline polyester resin C-1] was changed to [crystalline polyester resin C-3] and [WAX dispersion liquid 1] was changed to [WAX dispersion liquid 2] in the preparation of [crystalline polyester resin dispersion liquid C-1], and the heating temperature for the agglomerated slurry 1 was changed to 75° C. in the agglomeration and fusion step.

### Example 4

In Example 1, [crystalline polyester resin C-1] is changed to [crystalline polyester resin C-2] in the preparation of [crystalline polyester resin dispersion solution C-1] to obtain [toner 4].

### Example 5

In Example 1, [Crystalline Polyester Resin C-1] was changed to [Crystalline Polyester Resin C-2] and [WAX Dispersion 1] was changed to [WAX Dispersion 2] in the preparation of [Crystalline Polyester Resin Dispersion C-1] to obtain [toner 5].

### Example 6

In Example 1, [crystalline polyester resin C-1] was changed to [crystalline polyester resin C-2] and [WAX dispersion liquid 1] was changed to [WAX dispersion liquid 2] in the preparation of [crystalline polyester resin dispersion liquid C-1], and the heating temperature for the agglomerated slurry was changed to 72° C. in the agglomeration and fusion step to obtain [toner 6].

### Example 7

In Example 1, [crystalline polyester resin C-1] was changed to [crystalline polyester resin C-6] and [WAX dispersion liquid 1] was changed to [WAX dispersion liquid 2] in the preparation of [crystalline polyester resin dispersion liquid C-1], and the heating temperature for the agglomerated slurry was changed to 72° C. in the agglomeration and fusion step to obtain [toner 7].

### Comparative Example 1

In Example 1, [crystalline polyester resin C-1] was changed to [crystalline polyester resin C-4] and [WAX dispersion liquid 1] was changed to [WAX dispersion liquid 2] in the preparation of [crystalline polyester resin dispersion liquid C-1], and the heating temperature for the agglomerated slurry was changed to 72° C. in the agglomeration and fusion step to obtain [toner 7′].

### Comparative Example 2

In Example 1, [Crystalline Polyester Resin C-1] was changed to [Crystalline Polyester Resin C-4] and [WAX Dispersion 1] was changed to [WAX Dispersion 2] in the preparation of [Crystalline Polyester Resin Dispersion C-1], and the heating temperature for the agglomerated slurry was changed to 75° C. in the agglomeration and fusion step to obtain [toner 8].

### Comparative Example 3

In Example 1, [Crystalline Polyester Resin C-1] was changed to [Crystalline Polyester Resin C-5] and [WAX Dispersion 1] to [WAX Dispersion 2] in the preparation of [Crystalline Polyester Resin Dispersion C-1], and the heating temperature for the agglomerated slurry was changed to 65° C. in the agglomeration and fusion step to obtain [toner 9].

### Comparative Example 4

In Example 1, [Crystalline Polyester Resin C-1] was changed to [Crystalline Polyester Resin C-4] and [WAX Dispersion 1] to [WAX Dispersion 2] in the preparation of [Crystalline Polyester Resin Dispersion C-1], and the heating temperature for the agglomerated slurry was changed to 65° C. in the agglomeration and fusion step to obtain [toner 10].

### Comparative Example 5

In Example 1, [crystalline polyester resin C-1] was replaced with [crystalline polyester resin C-4] in the preparation of [crystalline polyester resin dispersion liquid C-1], and the heating temperature for the agglomerating slurry was changed to 68° C. in the agglomerating and fusing step to obtain [Toner 11].

The compositions of the oil phases of Examples 1-6 and Comparative Examples 1-5 are shown in Table 1.

⬆“in Table 1 means” same as described in the above column.

TABLE 1

| | | | | Heating |
|---|---|---|---|---|
| | Oil Phase | | | temperature of |
| | amorphous | crystalline | WAX | agglomeration |
| | polyester resin | polyester | dispersion | slurry(° C.) |
| Example 1 | amine extension | C-1 | WAX | 70 |
| | of prepolymer 1, | | dispersion | |
| | polyester resin 1 | | liquid 1 | |
| Example 2 | Same as above | C-2 | WAX | 70 |
| | | | dispersion | |
| | | | liquid 2 | |
| Example 3 | Same as above | C-3 | WAX | 70 |
| | | | dispersion | |
| | | | liquid 2 | |
| Example 4 | Same as above | C-2 | WAX | 70 |
| | | | dispersion | |
| | | | liquid 1 | |
| Example 5 | Same as above | C-2 | WAX | 70 |
| | | | dispersion | |
| | | | liquid 2 | |
| Example 6 | Same as above | C-2 | WAX | 72 |
| | | | dispersion | |
| | | | liquid 2 | |
| Example 7 | Same as above | C-6 | WAX | 72 |
| | | | dispersion | |
| | | | liquid 2 | |
| Comparative | Same as above | C-4 | WAX | 72 |
| example 1 | | | dispersion | |
| | | | liquid 2 | |
| Comparative | Same as above | C-4 | WAX | 75 |
| example 2 | | | dispersion | |
| | | | liquid 2 | |
| Comparative | Same as above | C-5 | WAX | 65 |
| example 3 | | | dispersion | |
| | | | liquid 2 | |
| Comparative | Same as above | C-4 | WAX | 65 |
| example 4 | | | dispersion | |
| | | | liquid 2 | |
| Comparative | Same as above | C-4 | WAX | 68 |
| example 5 | | | dispersion | |
| | | | liquid 1 | |

Table 2 shows the physical properties of wax and the shape measured by the aforementioned measurement method, the physical properties of crystalline polyester resin and the coverage of crystalline polyester resin measured by the aforementioned measurement method, and the conditions of agglomerated slurry in Examples 1-6 and Comparative Examples 1-5.

TABLE 2

| | Wax | | | | crystalline polyester | | | | |
|---|---|---|---|---|---|---|---|---|---|
| | domain | melting | SP | | Number of | melting | SP | | Δ |
| | diameter | point | value | aspect | crystalline | point | value | coverage | SP |
| | (μm) | (° C.) | (cal/cm³)^{1/2} | ratio | polyester | (° C.) | (cal/cm³)^{1/2} | ratio(%) | value |
| Example 1 | 0.9 | 67 | 9.5 | 1.6 | C-1 | 74.9 | 10.2 | 81 | 0.7 |
| Example 2 | 0.5 | 70.4 | 9.7 | 1.5 | C-2 | 72 | 10.0 | 88 | 0.3 |
| Example 3 | 0.3 | 70.4 | 9.7 | 1.4 | C-3 | 78.8 | 9.7 | 83 | 0.0 |
| Example 4 | 0.9 | 67 | 9.5 | 1.4 | C-2 | 72 | 10.0 | 81 | 0.5 |
| Example 5 | 0.7 | 70.4 | 9.7 | 1.4 | C-2 | 72 | 10.0 | 81 | 0.3 |
| Example 6 | 0.4 | 70.4 | 9.7 | 1.3 | C-2 | 72 | 10.0 | 93 | 0.3 |
| Example 7 | 0.4 | 70.4 | 9.7 | 1.2 | C-6 | 71 | 10.8 | 95 | 1.1 |
| Comparative | 1.2 | 70.4 | 9.7 | 1.5 | C-4 | 47 | 10.9 | 83 | 1.2 |
| example 1 | | | | | | | | | |
| Comparative | 1.6 | 70.4 | 9.7 | 1.4 | C-4 | 47 | 10.9 | 83 | 1.2 |
| example 2 | | | | | | | | | |
| Comparative | 0.6 | 70.4 | 9.7 | 1.8 | C-5 | 65 | 9.8 | 40 | 0.1 |
| example 3 | | | | | | | | | |
| Comparative | 0.5 | 70.4 | 9.7 | 1.8 | C-4 | 47 | 10.9 | 75 | 1.2 |
| example 4 | | | | | | | | | |
| Comparative | 1.2 | 67 | 9.5 | 1.7 | C-4 | 47 | 10.9 | 30 | 1.4 |
| example 5 | | | | | | | | | |

### <Preparation of Carrier>

The resin layer coating liquid was prepared by adding 100 parts of silicone resin (organostraight silicone), 5 parts of γ-(2-aminoethyl)aminopropyltrimethoxysilane, and 10 parts of carbon black to 100 parts of toluene, and dispersing the mixture with a homo mixer for 20 minutes. The resin layer coating liquid was prepared. The carrier was prepared by applying the resin layer coating liquid to the surface of 1,000 parts of spherical magnetite with a volume average particle diameter of 50 μm using a fluidized bed coating apparatus.

### <Preparation of Developer>

Using a ball mill, 5 parts of each [toner] and 95 parts of each [carrier] were mixed to prepare each [developer].

Next, the obtained toners and developers were evaluated for various properties as follows.

### <Low-Temperature Fixability>

Composite resin particles are uniformly placed on the paper surface at 0.8 mg/cm². The method of placing the powder on the paper surface is to use a printer without a heat fusing machine. Other methods may be used if the powder can be uniformly placed at the above weight density. The cold offset generation temperature (MFT) was measured when the paper was passed through the pressure roller at a fusing speed (peripheral speed of the heating roller) of 213 mm/see and a fusing pressure (pressure roller pressure) of 10 kg/cm². The lower the cold offset occurrence temperature, the better the low-temperature fusing performance.

### Evaluation Criteria

A: The lower limit of fusing temperature is less than 130° C.
B: The lower limit of fusing temperature is greater than 130° C. and less than 135° C.
C: The lower limit of fusing temperature is greater than 135° C. and less than 140° C.
D: The lower limit of fusing temperature is greater than 140° C.

### <Heat-Resistant Storage Stability>

A 50-mL glass vessel was charged with toner, allowed to stand at a temperature of 50° C. for 24 hours, and cooled to 24° C. Next, the penetration degree [mm] was measured by the penetration degree test (JISK2235-1991) to evaluate the heat storage resistance.

### Evaluation Criteria

A: Penetration of 20 mm or more
B: Insertion degree 15 mm or more and less than 20 mm
C: Insertion degree 10 mm or more and less than 15 mm
D: Penetration less than 10 mm

### <Image Quality>

A color production printer (Ricoh Pro C7210S, manufactured by Ricoh Company, Ltd.) was used to form a standard line chart image (output image) for 400 dpi evaluation on coated paper (POD gloss coated paper, manufactured by Oji Paper Company). The output image was formed so that a solid black line image was created. The formed fine line areas were compared with the original file image, and the reproducibility was evaluated according to each standard in the table below. An evaluation result of “3” or higher indicates a usable level for practical use.

### [Evaluation Standards]

5: The image of the continuous line section of the original image is reproduced without any missing parts of highly brilliant lines when observed with a loupe.

4: A slight partial omission of the line image can be seen when observed with a loupe at a magnification of 100×.

3: Partial omission of the line image is observed with a loupe at 100× magnification.

2: Partial missing parts of the line image can be seen visually.

1: Continuous missing portions of the line image are clearly visible visually.

The evaluation results of Examples 1 to 7 and Comparative Examples 1 to 5 are shown in Table 3.

TABLE 3

| | Low-temperature | Heat-resistant | Image |
|---|---|---|---|
| | fixability | storage stability | quality |
| Example 1 | B | B | 3 |
| Example 2 | A | B | 3 |
| Example 3 | B | B | 4 |
| Example 4 | A | B | 4 |
| Example 5 | A | B | 4 |
| Example 6 | A | A | 5 |
| Example 7 | A | A | 5 |
| Comparative example 1 | C | C | 3 |
| Comparative example 2 | C | C | 2 |
| Comparative example 3 | C | C | 2 |
| Comparative example 4 | C | D | 1 |
| Comparative example 5 | D | D | 1 |

The results in Table 3 show that Examples 1-7 of the present invention exhibit excellent performance in terms of low temperature fusing, thermal stability, and image quality. On the other hand. Comparative Examples 1-5 were found to deteriorate in low temperature fusing property, heat preservation, and image quality.

What is claimed is:

1. A resin particle, comprising;
a binder resin,
a crystalline polyester resin; and
a release agent being in a plurality of domains, which have a domain diameter of 1 μm or less;
wherein more than 80% of a surface of each of the plurality of domains of the release agent is covered with the crystalline polyester resin, and
a melting point of the crystalline polyester resin is higher than a melting point of the release agent.

2. The resin particle according to claim 1, wherein an absolute value of a difference (ASP value) between a SP value of the releasing agent and a SP value of the crystalline polyester resin is 1.1 (cal/cm³)^{1/2} or less.

3. The resin particle according to claim 1, wherein the binder resin comprises an amorphous polyester resin synthesized from an aliphatic alcohol monomer.

4. The resin particle according to claim 1, wherein each of the plurality of domains of the release agent is in a spherical shape.

5. A toner, comprising the resin particles of claim 1.

6. A method of manufacturing a resin particle, comprising;
performing an oil phase preparation step in which a binder resin comprising a crystalline polyester resin and a release agent are dissolved or dispersed in an organic solvent to obtain an oil phase;
performing a phase transfer emulsification step in which an aqueous phase is added to the oil phase to form an oil-in-water dispersion liquid;
performing a desolvating step in which the organic solvent is removed from the oil-in-water dispersion liquid to obtain a particulate dispersion liquid; and
performing an agglomerating step to agglomerate particles of the particulate dispersion liquid.

7. An image forming apparatus, comprising:
an electrostatic latent image bearer,
an electrostatic latent image former to form an electrostatic latent image on the electrostatic latent image bearer; and
a developer to store the toner according to claim 5 to develop the electrostatic latent image to form a toner image.

8. An image forming method comprising:
forming an electrostatic latent image on an electrostatic latent image bearer; and
developing the electrostatic latent image with the toner according to claim 5 to form a toner image.

9. The resin particle according to claim 1, wherein an aspect ratio of each of the plurality of domains of the release agent is 1.2 or less.

10. The resin particle according to claim 1, wherein a glass transition temperature (Tg) of the binder resin is 35° C. to 80° C.

11. The resin particle according to claim 1, wherein the release agent comprises a wax having a melting point of 50° C. to 120° C.

12. The resin particle according to claim 11, wherein a content of the wax in the resin particle is in a range from 3% by mass to 30% by mass.

13. The resin particle according to claim 11, wherein a melt viscosity of the wax is within a range from 5 cps to 1,000 cps.

14. The resin particle according to claim 1, wherein the crystalline polyester resin is synthesized from a polyvalent alcohol and a polyvalent carboxylic acid.

15. The resin particle according to claim 1, wherein the crystalline polyester resin is synthesized from a linear saturated aliphatic dicarboxylic acid having a carbon number of 4 to 12 and a linear saturated aliphatic diol having a carbon number of 2 to 12.

16. The resin particle according to claim 1, wherein the crystalline polyester resin has a weight-average molecular weight (Mw) of 3,000 to 30,000, a number-average molecular weight (Mn) of 1,000 to 10,000, and a weight-average molecular weight (Mw) to number-average molecular weight (Mn) ratio Mw/Mn of 1 to 10.

17. The resin particle according to claim 1, wherein an acid value of the crystalline polyester resin is 7 mgKOH/g or more and 45 mgKOH/g or less.
